(19) United States
(12) Patent Application Publication
(10) Pub. No.: US 2021/0110316 A1
(43) Pub. Date: Apr. 15, 2021

(54) PERSONAL AND/OR TEAM LOGISTICAL SUPPORT APPARATUS, SYSTEM, AND METHOD

(71) Applicant: The Idealogic Group, Inc, Las Vegas, NV (US)

(72) Inventor: Dennis Fountaine, San Diego, CA (US)

(73) Assignee: The Idealogic Group, Inc, Las Vegas, NV (US)

(21) Appl. No.: 17/071,870

(22) Filed: Oct. 15, 2020

Related U.S. Application Data
(60) Provisional application No. 62/915,374, filed on Oct. 15, 2019.

(51) Int. Cl. G06Q 10/06; G06F 3/16; H04W 4/029; G06F 1/16

(52) U.S. Cl. CPC G06Q 10/06; G06F 1/163; H04W 4/029; G06F 3/167

(57) ABSTRACT

Disclosed are a method, a device, a system and/or a manufacture of personal and/or team logistical support. In one embodiment, a system for geospatial reminder and documentation includes a server communicatively coupled to a device (e.g., a mobile device, a wearable device). A spatial documentation routine of the server that receives a documentation placement request that includes a documentation content data and a first location data from the device to generate a spatial documentation data. A documentation awareness routine of the server receives a second location data from the device and determines a second coordinate of the second location data is within a threshold distance of the first coordinate. The server transmits a first indication instruction to trigger an awareness indicator on the device such as a vibration, to alert the user to the documentation in context. A documentation retrieval routine may then respond to requests for the documentation.

### CLAIM FOR PRIORITY

This patent application claims priority from, and hereby incorporates by reference: U.S. provisional patent application No. 62/915,374, titled ‘LOGISTICS AND ASSISTANCE SUPPORT HUB, SYSTEM AND METHOD’, filed Oct. 15, 2019.

### FIELD OF TECHNOLOGY

This disclosure relates generally to data processing devices and, more particularly, to a method, a device, and/or a system of personal and/or team logistical support.

### BACKGROUND

Individuals and teams of people working together (e.g., families, organizations, companies, business units, departments, government agencies) may have a large variety of things to remember, information to document, and/or objects to use and share. Faced with a growing and changing variety of information and available tools it may be increasingly difficult to remember personally relevant information and/or communicate information relevant to a team, including the efficient use of shared tools and resources. These challenges can result in logistical inefficiencies, for example trying to find where a family member or co-worker placed important objects, receiving an effective reminder that follows up and precipitates action, and/or conveying relevant information or documentation to a person at the most relevant time and within the most relevant context. With respect to both individuals and teams, there is a continuing need for technology that improves logistics in everyday tasks, including reminders, documentation, and/or object location, each of which may closely relate to the workflow of households, businesses, and government.

### SUMMARY

Disclosed are a method, a device, and/or a system of personal and/or team logistical support. In one embodiment, a system for geospatial reminder and documentation includes a server and a network communicatively coupling the server to a mobile device and/or a wearable device. The server includes a processor of the server, a memory of the server, a network interface controller of the server, a spatial documentation routine, and a documentation awareness routine.

The spatial documentation routine includes computer readable instructions that when executed on the processor of the server: receive a documentation placement request that includes a documentation content data (comprising of a text file of a documentation, a voice recording of the documentation, and/or a video recording of the documentation) and optionally a documentation name and a documentation category; receive a first location data from a mobile device and/or a wearable device; and generate a spatial documentation data and store the spatial documentation data. The spatial documentation data includes a documentation ID, the documentation content data, a documentation location data including a first coordinate of the first location data, and optionally the documentation name and the documentation category.

The documentation awareness routine includes computer readable instructions that when executed on the processor of the server: receive a second location data from the mobile device and/or the wearable device and determine a second coordinate of the second location data is within a threshold distance of the first coordinate of the documentation location data. The documentation awareness routine includes computer readable instructions that when executed on the processor of the server: determine an awareness indicator of the spatial documentation data and transmit a first indication instruction to trigger the awareness indicator on the mobile device and/or the wearable device. The awareness indicator is a sound and/or a vibration used to alert the user to documentation.

The server may further include a documentation retrieval routine including computer readable instructions that when executed on the processor of the server may: receive a documentation retrieval request that includes the documentation ID from, the retrieval request received from the mobile device and/or the wearable device; and/or transmit the documentation name, the documentation content data, and/or the documentation category.

The server may further include a locating routine including computer readable instructions that when executed on the processor of the server may: receive an object placement request that may include an object name and optionally an object description data and/or an object category; receive a third location data from the mobile device and/or the wearable device; generate a placed object data (that may include a placement ID, the object name and the object ID, an object location data, and/or the object description data and the object category); and/or store the placed object data.

The server may also include an object locating routine. The object locating routine may include computer readable instructions that when executed on the processor of the server may: receive an object locating request that includes the object name, the object ID, and/or the object description; determine a third coordinate of the object location data and/or an area name associated with the object location data; and/or transmit the third coordinate and/or the object location name to the wearable device and/or the mobile device.

The server may further include a voice recognition system and/or a remote procedure call to the voice recognition system, the voice recognition system receiving a voice input of a first user and generating a text output. The server may also include a set of computer readable instructions that when extracted extract from the text output: (i) the documentation content data, the documentation name, and the documentation category, and/or (ii) the object name, the object description data, the object category, and the area name.

The system may further include the wearable device of the first user. The wearable device of the first user may include a display screen of the wearable device, a processor of the wearable device, a network interface controller of the wearable device, and an activation button of the wearable device that is at least one of a virtual button and a physical button. The wearable device of the first user may also include a voice transmission routine of the wearable device including computer readable instructions that when executed on the processor of the wearable device may determine activation of the activation button and/or record the voice input of the first user; and transmit the voice input to the server.

The server may also include a group database and a collective memory engine. The group database may store an association between the user ID of the first user and a group ID. The collective memory engine may include computer readable instructions that when executed on the processor of the coordination server may: receive a fourth location data from a mobile device of a second user and/or a wearable device of the second user; determine a user ID of the second user is associated with the group ID; determine a third coordinate of the fourth location data is within the threshold distance of the coordinate of the documentation location data; determine the awareness indicator of the spatial documentation data; and transmit a second indication instruction to execute the awareness indicator on the at least one of the mobile device of the second user and/or the wearable device of the second user.

The collective memory engine may include computer readable instructions that when executed on the processor of the coordination server may: receive a second object locating request (that may include the object name, the object ID, and/or the object description) received from the at the mobile device of the second user and/or the wearable device of the second user; determine the third coordinate of the object location data and/or an area name associated with the object location data; and transmit the third coordinate and/or the area name to the mobile device of the second user and/or the wearable device of the second user.

In another embodiment, a personal and/or team logistics support system includes a support hub, a wearable device of a first user, and a network communicatively coupling the support hub and the wearable device of the first user. The support hub includes a processor of the support hub, a memory of the support hub, a network interface controller of the support hub, and a display screen of the support hub. A housing of the support hub stores the processor of the support hub, the memory of the support hub, the network interface controller of the support hub, and the display screen of the support hub is set in the housing.

The support hub also includes a voice recognition system and/or a remote procedure call to the voice recognition system, the voice recognition system receiving a voice input of a first user and generating a text output.

The support hub includes a calendar application comprising one or more calendar grids for display on the display screen and a reminder database storing a reminder data. The reminder data includes a reminder ID, a reminder name, a reminder condition data, a reminder content data (including a text file of a reminder, a voice recording of the reminder, and/or a video recording of the reminder), a reminder category, a user ID of a first user defining the reminder, and a reminder location data.

The support hub further includes a reminder routine having computer readable instructions that when executed on the processor of the support hub: (i) receive the text output of the first user; (ii) extract a reminder content data and a reminder condition from the text output; and (iii) record the reminder data in the reminder database.

The wearable device of the first user includes a processor of the wearable device, a network interface controller of the wearable device, a display screen of the wearable device, and an activation button of the wearable device that is at least one of a virtual button and a physical button. The wearable device of the first user further includes a voice transmission routine of the wearable device. The voice transmission routine of the wearable device includes computer readable instructions that when executed on the processor of the wearable device: determine activation of the activation button; record the voice input of the first user; and transmit the voice input to the support hub.

The system may further include a mobile device of the first user. The mobile device may include a processor of the mobile device, a memory of the mobile device, a GPS unit, and a voice transmission routine of the mobile device. The voice transmission routine of the mobile device includes computer readable instructions that when executed on the processor of the mobile device may record the voice input of the first user and/or transmit the voice input to the support hub.

The support hub may further include an object database storing a placed object data having an object name and an object location data, an object description data, an object category, and/or a user ID of the first user. The support hub may also include an object locating engine that includes computer readable instructions that when executed on the processor of the support hub may: receive a second text output of the first user; extract at least one of the object name, the object description, and/or the object category from the second text output of the first user; extract a coordinate of the object location data from a location data received from the mobile device; and record the placed object data in the object database.

The system may also include a coordination server. The coordination server may include a processor of the coordination server, a memory of the coordination server, a collective reminder database, and/or a collective object database. The coordination server may include collective memory engine that includes computer readable instructions that when executed on the processor of the coordination server: receive a second reminder data and a group ID from the first user (the first user may be associated with the group ID); store the second reminder data in the collective reminder database; lookup a second user associated with the group ID; and deliver the reminder data to a second support hub of the second user.

The coordination server may also include a collective object database. The collective memory engine may further include computer readable instructions that when executed on the processor of the coordination server may: receive a second placed object data and the group ID from the first user (the first user may be associated with the group ID); store a second object data in the collective object database; lookup the second user associated with the group ID; and/or deliver the second object data to the second support hub of the second user.

The support hub may include a display screen of the support hub that is a touchscreen. The support hub may also include a pen mount connected to the housing for storing a pen capable of stimulating a touch input of the touchscreen. The support hub may also include a writing recognition system and/or a second remote procedure call to the writing recognition system, the writing recognition system receiving a written input of the first user and generating the text output. The support hub may further include an event database storing a jurisdiction event data, a personal event data, and/or a collective event data. The support hub may yet further include a scheduling routine that includes computer readable instructions that when executed on the processor of the support hub: receive the text output of the first user; extract a date and optionally a time from the text output; and record an event data as an instance of the personal event data in the event database.

In yet another embodiment, a computer implemented method in support of personal and/or team logistics includes receiving a reminder request including a reminder content data (including a text file, a voice recording and/or a video recording), and a reminder category and/or a user ID of a first user generating the reminder request. The method generates a reminder condition data including a first reminder condition and a second reminder condition of higher urgency than the first reminder condition. The method includes associating within the reminder condition data a first communication medium ID with the first reminder condition and a second communication medium ID with the second reminder condition. The method generates and stores a reminder data including a reminder ID, the reminder condition data, the reminder content data, and optionally the user ID of the first user generating the reminder request.

The method may then determine the occurrence of the first reminder condition. The first communication medium ID that is associated with the first reminder condition may be determined. A reminder notification data that includes the reminder content data is generated and transmitted through the first communication medium to a wearable device of the first user, a mobile device of the first user, and/or a different computer device of the first user. The method may also determine the occurrence of the second reminder condition of the higher urgency, determine the second communication medium ID that is associated with the second reminder condition; and re-transmitting the reminder notification data through the second communication medium to the wearable device of the first user, the mobile device of the first user, and/or the different computer device of the first user.

### BRIEF DESCRIPTION OF THE DRAWINGS

The embodiments of this disclosure are illustrated by way of example and not limitation in the figures of the accompanying drawings, in which like references indicate similar elements and in which:

FIG. 1 is a support network in which a user (e.g., an individual, a member of a team) is provided logistical support through use of a support hub, and a device (e.g., a mobile device and/or a wearable device), the support hub including an object locating engine for storage and locating of a placed object, a recall engine for setting and recalling reminders, and a spatial documentation engine for geospatial documentation, and the support network further illustrating a coordination server comprising a collective memory engine that may facilitate reminders, documentation, and/or object location among teams, according to one or more embodiments.

FIG. 2A is a support server that may be a remote implementation of the support hub of FIG. 1, and further illustrating a speech recognition system, a writing recognition system (e.g., to permit handwritten data entry on the device of the user), an events database for storing event data, an object database for storing placed object data including an object location data, a reminder database for storing reminders including a reminder condition tied to a communication medium, and a spatial documentation database storing a spatial documentation data including an awareness indicator to assist in presenting documentation in context, according to one or more embodiments.

FIG. 2B illustrates the support hub of FIG. 1, including a display screen which can display reminders, documentation, a calendar of events, and/or a map of locations including placed objects, and further illustrating a pen for a handwriting interface, and a speaker and a microphone to provide a voice interface, according to one or more embodiments.

FIG. 3 illustrates a wearable device of the user (e.g., a smart watch), including a speaker, a microphone, and a command button that can automatically transmit location data and/or a voice input data to the support server of FIG. 2A and/or the support hub of FIG. 2A, according to one or more embodiments.

FIG. 4 illustrates the coordination server of FIG. 1, including a collective memory engine that may enable the allocation, sharing, and management of remainders, documentation, and/or placed object data among multiple instances of the support hub and/or devices of users, the coordination server further illustrating a group database, and a collective database that may store the reminder data, the spatial documentation data, and/or the placed object data, according to one or more embodiments.

FIG. 5 illustrates a mobile device of the user, including a GPS unit for automatic transmission of location data and the display screen able to display a map including an object location, a reminder location, a documentation location, and and/or other logistical support information, according to one or more embodiments.

FIG. 6 illustrates a reminder creation process flow, according to one or more embodiments.

FIG. 7 illustrates a reminder notification process flow, according to one or more embodiments.

FIG. 8 illustrates a documentation creation process flow, according to one or more embodiments.

FIG. 9 illustrates a document request process flow, according to one or more embodiments.

FIG. 10 illustrates an object placement process flow, according to one or more embodiments.

FIG. 11 illustrates an object locating process flow, according to one or more embodiments.

FIG. 12 illustrates a voice input process flow, according to one or more embodiments.

FIG. 13 illustrates an example of the support hub, including a display screen, a physical button for providing commands, a camera, a housing, a speaker, and a microphone, the support hub communicatively coupled to one or more devices through a local area network such as a smart watch, according to one or more embodiments.

FIG. 14 illustrates an example use of the support server of FIG. 2A to support a business with a set of reminders, spatial documentation, and locating of placed objects within a location of the business, the example including a logistics support map view illustrating information usable by one or more users associated with the small business, according to one or more embodiments.

Other features of the present embodiments will be apparent from the accompanying drawings and from the detailed description that follows.

### DETAILED DESCRIPTION

Disclosed are a method, a device, and/or system of personal and/or team logistical support. Although the present embodiments have been described with reference to specific example embodiments, it will be evident that various modifications and changes may be made to these embodiments without departing from the broader spirit and scope of the various embodiments.

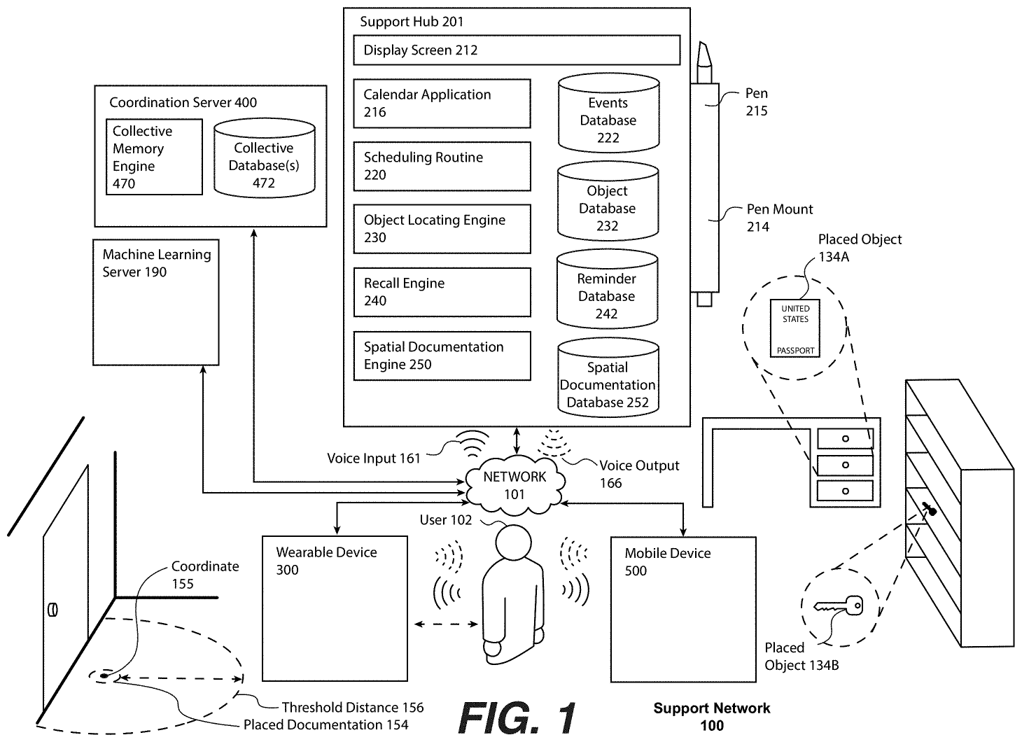

FIG. 1 illustrates a support network 100, according to one or more embodiments. In FIG. 1, a user 102 and/or a team of users 102 may utilize the support network 100 for use in daily logistics and/or support, for example scheduling events, setting and recalling reminders, setting and retrieving spatial documentation, and/or recording the location and/or spatially indexing of placed objects 134. For example, the support network 100 is also usable for defining, organizing, and being reminded of tasks (e.g., as may be useful for project management) and/or documenting and querying the location of placed objects 134 (e.g., useful in family settings or workplaces with shared tools and equipment). Depending on the configuration of the present embodiments, the support network 100 can be deployed for personal use, business use, individual use, and/or for use in groups of individuals or organizations. The support network 100 may include a number of accessible user interfaces, including voice-based activation and control by the user 102, writing directly on the display screen 212 of the support hub 201, and/or automated event, task, and/or placed object 134 determination and documentation. In one or more embodiments, the support network 100 may be useful in many contexts, for example from use by for two college roommates to use by a group of scientist at a NASA facility.

In one or more embodiments and the embodiment of FIG. 1, the support hub 201 is communicatively coupled through a network 101 to a wearable device 300 of the user 102, a coordination server 400, a mobile device 500 of the user 102 and/or a machine learning server 190. The network 101 may be comprised of a piconet (e.g., Blutooth®), a local area network (LAN) including WiFi, a wide area network (WAN), a virtual private network (VPN), and/or the Internet. The support hub 201 includes a calendar application 216 that can display a calendar grid 217 on the display screen 212 of the support hub 201 including presentation of one or more pieces of data representing events (referred to as an event data) stored in an events database 222. The display screen 212 can also display a map of one or more placed objects 134 in the object database 232.

A scheduling routine 220 can receive data (e.g., generated by the user 102) and parse the data to define an event data to be stored in the events database 222. An object locating engine 230 can similarly receive and/or parse data (e.g., generated by the user 102) to define a placed object data 231 in the object database 232, in one or more embodiments. A recall engine 240 can receive and/or parse data to define a reminder data 241 in the reminder database 242, in one or more embodiments. A spatial documentation engine 250 can store receive and/or parse data to store a spatial documentation data 251 in a spatial documentation database 252, in one or more embodiments. Each of the functions, properties and/or advantages of the scheduling routine 220, the object locating engine 230, the recall engine 240, and/or the spatial documentation engine 250 will be shown and described below, and throughout the present embodiments.

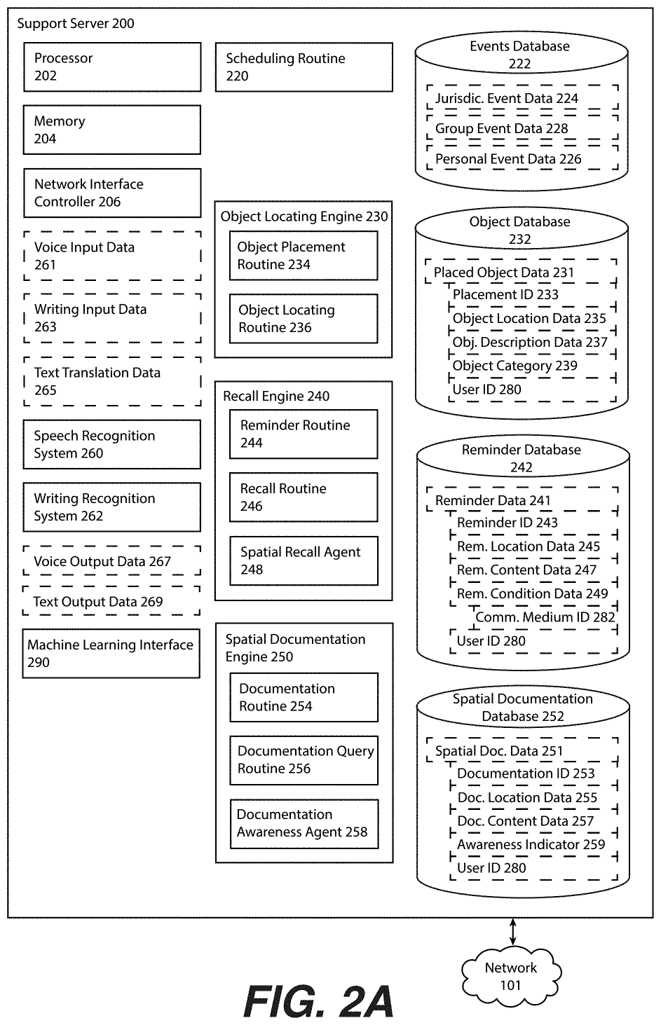

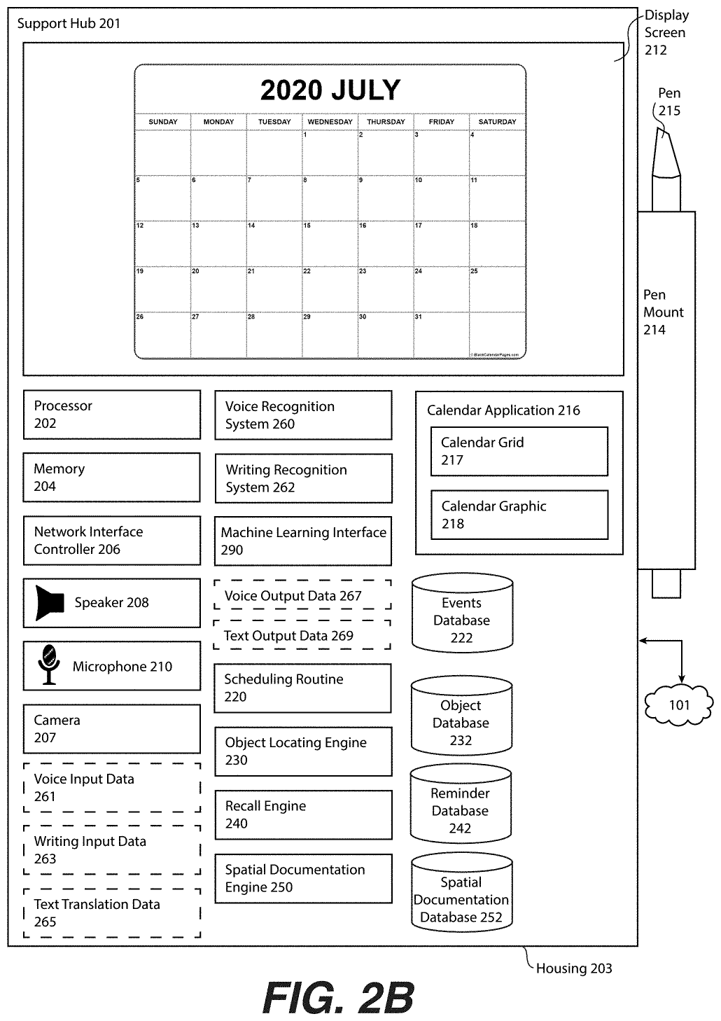

In one or more embodiments, the user 102 may directly utilize the support hub 201 when in the presence of the support hub 201. In one or more embodiments, the user 102 may request scheduling of an event, log completion of a task, set a reminder, record a piece of documentation including within a spatial context and/or conditional context, and/or to record a placed object 134. For example, in what may be a basic example, the user 102 may activate the recording and transmission capability of the support hub 201, as shown and described herein, and say: “set a dinner party event for July fourteenth”, or “remind me to buy a birthday present for my wife three days before her birthday.” The voice input 161 is recorded as a voice input data 261, processed through a speech recognition system 260, and parsed to define one or more events in the events database 222, as shown and described in conjunction with FIG. 2. In what may be a more complex example, the user 102 may activate the recording and transmission capability of the support hub 201, and say “I placed the thermocouple in the fourth floor laboratory closet.” Computer readable instructions of the support hub 201 may then index the term “thermocouple”, index a location of one of a number of preset and/or learned locations (e.g., “fourth floor”, “laboratory” and/or “closet”), and may store the resulting data in the spatial documentation database 252. The support hub 201 may utilize voice-activated assistance services such as Amazon® Alexa, Apple® Siri, or Google® Plus to recognize speech (e.g., as the speech recognition system 260), including use of voice-enabled applications (e.g., “skills”). Machine learning techniques may be utilized to assist in identifying parts of speech, patterns of requests, and/or to recognize locations submitted in association with requests.

In one or more embodiments, the user 102 may also utilize the pen 215 to input data, which may be mounted on the support hub 201, by writing on the display screen 212. In one or more embodiments, the display screen 212 is a touchscreen and the pen 215 is a stylus usable to provide an input on the touchscreen. In one or more embodiments, the user 102 may be able to generate an event data by writing directly on the calendar grid 217, or a reminder data 241 and/or a spatial documentation data 251 by writing directly on a map. As a result, the user 102 may be able to emulate a familiar process of writing an event on a paper calendar, recording a reminder on a checklist, and/or providing a handwritten documentation note on a map. The writing of the user 102 can be parsed through a writing recognition system. Events, reminders, and/or documentation can then be recognized, extracted, and stored in one or more appropriate databases shown in the embodiment of FIG. 1 and FIG. 2A.

The support hub 201 may be configured for convenience within a home or office setting such that it always displays useable information to the user 102. For example, the display screen 212 of the support hub 201 may by default display a monthly calendar with events specified and/or a daily schedule presented. The support hub 201 may provide reminders for event data stored in the event database 222 (e.g., “you have a call with International Systems Incorporated in ten minutes”). In a warehouse environment, in contrast, the support hub 201 may primarily display a map of placed objects 134 or critical pieces of spatial documentation that can alert a user if they are determined to be near a hazard as sensed through location analysis of the wearable device 300 (e.g., resulting in a message: “Warning! Hydraulic oil leak at loading dock four”).

The user 102 may also use the support hub 201 to document placed objects 134. For example, the user 102 may say, “I placed my passport in the second desk drawer in my study”, or “I placed the key to my shed in the office bookshelf” The geographic location may also be inferred from GPS coordinates and/or other location placement information, as shown and described herein. A map can be displayed on the display screen 212 (e.g., a floorplan entered by the user 102, a satellite image from Google® Maps) and the user 102 can designate where a placed object 134 was placed utilizing the pen 215, including in conjunction with recording a voice memo that may be stored in the object database 232 (e.g., “the shed key is on the middle shelf”).

The user 102 may later request to query the object database 232, for example “Where did I put my passport?”. The support hub 201, as shown and described in the present embodiments, can then parse the query of the user 102 in natural language to determine presence of the query, check the object database 232, and reply through a voice output 166. The voice output 166, for example, might be “On June 22 at 3:46 PM you placed your Passport in the second drawer of the desk at 545 Westbrook Street.” In a family and/or workplace environment, uses may also be assigned certain authority to find objects of others, to be notified of certain reminders and/or documentation, and to participate in and/or receive other forms of logistical support.

The user 102 may also “place” documentation at a geospatial location and/or in association with some other piece of data specifying location. For example, as shown in the embodiment of FIG. 1, the user 102 may stand at a coordinate 155 next to a door and provide input according to a voice protocol. For example, the user 102 may say, “set documentation, indefinite time period, alert through device vibration.” Following a confirmation of a connection with the support hub 201, the user 102 may then provide content: “per fire department regulations, this is a fire door that should remain closed at all times—even when loading, DO NOT prop open the door”. The user 102 and/or a different user 102 moving within a threshold distance 156 of the coordinate 155 may then be alerted that the documentation is available for review, for example through a push notification to the mobile device 500 of the user 102 and/or the different user 102. The user 102 and/or the different user 102 may then request the full reminder (e.g., the sound recording of the content, a video of the content, a translated text of the content) and/or one or more pieces of metadata such as the user 102 who defined the spatial documentation 154 and/or a timestamp of the documentation.

The wearable device 300 and/or the mobile device 500 may act as extensions and further augment the support hub 201, according to one or more embodiments. The wearable device 300 and/or the mobile device 500 may “extend the range” of the support hub 201 farther than the distance from which the support hub 201 (and/or the support server of FIG. 2A) can be seen, heard, and/or spoken to by the user 102, for example into other parts of a home, office, or other environment of the support hub 201.

In addition, the wearable device 300 and/or the mobile device 500 can extend a capability of the support hub 201. For example, as may be known in the art, a combination of WiFi signal and GPS coordinates may permit a reasonably accurate determination of location within a building and such data can be automatically extracted and stored as the object location data 235 within the placed object data 231.

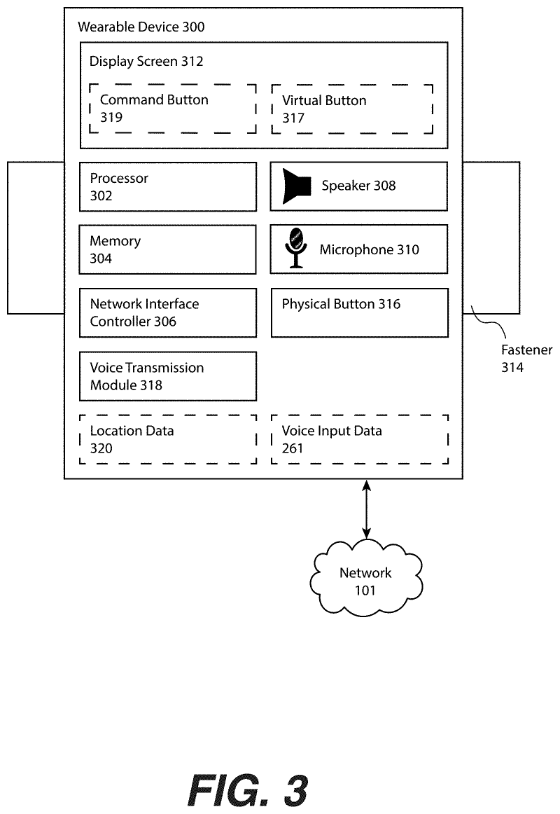

The wearable device 300 is a computing device attachable to the human body, for example a smart watch (e.g., Apple® Watch), and permitting communication from the user 102 to the support hub 201. In one or more preferred embodiments, the wearable device 300 can record a voice input 161 (e.g., to become the voice input data 261) of the user 102 and/or a text input. The wearable device 300 may also be able to provide a voice output 166 and/or a visual output (not shown in FIG. 3) such as a text or graphic. One skilled in the art will recognize that a wearable device 300 may include a microphone 310 and speaker 308 that can implement a remote voice-based interface to the support hub 201 without having visual text or graphic communication capability. Conversely, the wearable device 300 may have a display screen and may receive text and/or graphical input (e.g., selecting a graphic such as the command button 319), working as a visual-based interface to the support hub 201. The wearable device 300 may include a means of alerting the user 102, such as through a vibration generated by a motor. In one or more embodiments, the user 102 may be alerted to spatial reminders, documentation, and/or placed objects 134 when coming within a threshold distance of an associated geospatial coordinate or other locating data or another defined geofence.

In one or more embodiments, the user 102 may activate a routine on the wearable device 300 to transmit an input (e.g., a voice input data 261) to the support hub 201 through the network 101, for example to request scheduling of an event, to log completion of a task, and/or to document a placed object 134. The wearable device 300 may be connected to the support hub 201 through the network 101, for example through a shared WiFi connection and/or through a Bluetooth® connection. The wearable device 300 is shown and described in further detail in the embodiment of FIG. 3.

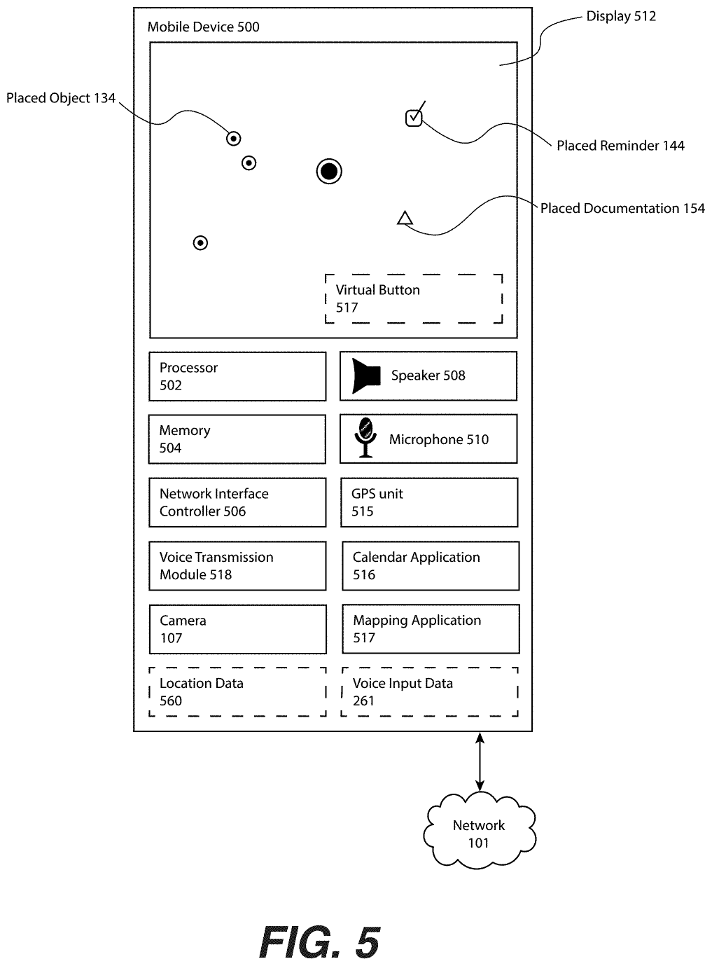

The mobile device 500 is a computing device comprising a display screen, for example a smartphone and/or a tablet device. The mobile device can similarly record and transmit voice or text to the support hub 201. However, the mobile device 500 may also be enabled to retrieve and show (e.g., through use of a mobile application) the calendar and events in the events database 222, the reminders of the reminder database 242, the placed objects of the object database 232, an/or documentation of the spatial documentation database 252. The mobile device 500 is shown and described in further detail in the embodiment of FIG. 5.

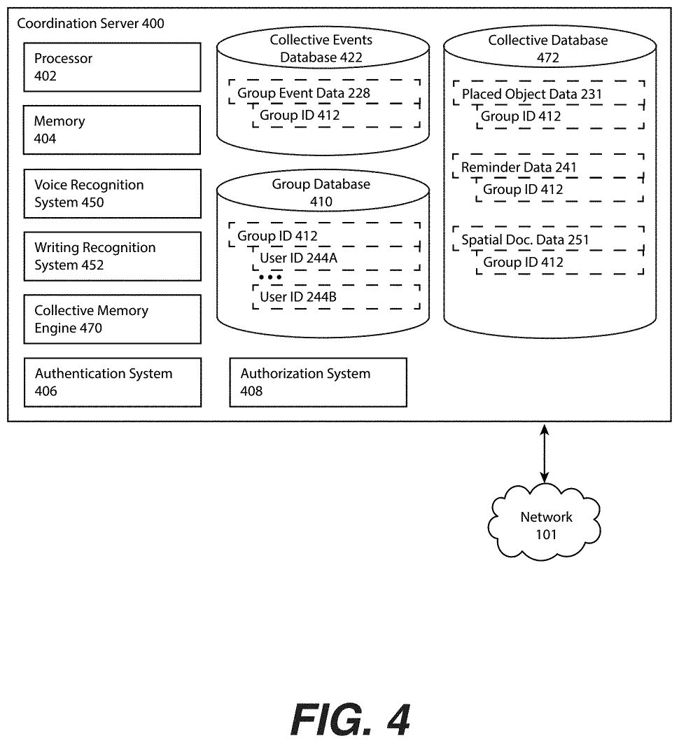

The coordination server 400 is a computing server that can enable more than one instance of the user 102 to utilize the support hub 201 (e.g., an executive and a secretary) and/or functionally associate one or more instances of the support hub 201 (and/or the support server 200 of FIG. 2A) together to form a group of coordinates hubs, devices, and/or servers. The coordination server 400 may include a group database 410 (not shown), and a set of collective database 472 (which may, for example, include one or more entries and/or data objects from the events database 222, the object database 232, the reminder database 242, and/or the spatial documentation database 252). A portion of the collective database storing one or more instance of the placed object data 231, the reminder data 241, and the spatial documentation data 251 may be referred to as the collective object database, the collective reminder database, and the collective documentation database, respectively. The group database 410, as shown in FIG. 4, may specify which instances of the user 102 and/or the support hub 201 are associated with a user group. An authentication system 406, as shown and described in conjunction with the embodiment of FIG. 4, may be used to authenticate one or more users 102, including such that it may be determined if a user 102 has permission to read and/or write to the collective database 472, or to be notified of events, reminders, placed objects 134, and/or placed documentation 154. For example, a collective events database within the collective database 472 may store event data applicable to the group, and a collective object database within the collective database 472 may store placed object data applicable to the group. The coordination server 400 is shown and described in further detail in the embodiment of FIG. 4.

FIG. 2 illustrates a support server 200, according to one or more embodiments. The support server 200 may provide many of the functions of the support hub 201, but may be instead operated at a remote location to primary use and/or within an on-site server room or networking equipment closet. The support server 200 may be appropriate, for example, for multitenant use (e.g., a subscription server), organizations spread over many physical locations. The support server 200 may also work in conjunction with one or more support hubs 201 placed at a location of use and connected through the network 101. The support server 200 and/or the support hub 201 may also have one or more of the elements depicted arbitrarily distributed between them, for example a remote backup of the object database 232 on the support server 200, and a local copy of the support server 200 on the object database 232 of the support hub 201.

The support server 200 of FIG. 2A comprises a processor 202 that is a computer processor, a memory 204 that is a computer memory (e.g., RAM, a solid-state memory, a hard disk), and a network interface controller 206. The support server may receive input from additional devices and/or systems over the network 101 (e.g., the wearable device 300, the coordination server 400, the mobile device 500, and/or other devices and systems), for example through remote procedure calls (RPC) and/or application programming interface (API) calls.

In one or more embodiments, the support server 200 may receive and record various media files from the user 102. For example, a “camera 507 of the mobile device 500 can be utilized for recording reminders of the user 102 which may then be transmitted to the support server 200, according to one or more embodiments. In a specific example, video recordings as reminders may be able to be used as a third-party reminder or remote accountability method, in which a third party reminds the user 102 to carry out or complete a task, or engage in a scheduled event.

The support server 200 includes interfacing elements sufficient for transmitting information to be generated on output devices for the user 102. For example, the support server 200 may transmit output to additional devices and systems over the network 101 (e.g., the support hub 201, the wearable device 300, the coordination server 400, the mobile device 500, and/or other devices and systems).

In one or more embodiments, the support server 200 is voice-enabled. The user 102 may generate a voice input 161 which is detected, recorded, and stored as a voice input data 261. The voice input data may be recorded upon detection of a “wake-word” such as “Memo”. Different wake works may also be assigned to and initiate certain requests, for example setting reminders, documentation, or recoding of placed objects 134. The voice input data 261 may be forwarded to a speech recognition system 260. The speech recognition system 260 comprises computer readable instructions that when executed on the processor 202 detect one or more words within the voice input data 261 and translate the one or more words into a text translation data 265. The speech recognition system 260 may also be provided on a different remote server and/or by a remote software service over the network 101. In such case, the support server 200 may include a remote procedure call (RPC) to the remote instance of the speech recognition system 260. In one or more other embodiments, the speech recognition system 260 may have both local (e.g., stored on the support hub 201 and/or the support server 200) and remote components specializing in certain aspects of voice recognition. For example, the speech recognition system 260 of the support hub 201 may have a sufficient library to recognize the wake word(s) and interpret some useful and/or common interactions in case connectivity issues with the network 101 arise. In a specific example, the local instance of the speech recognition system 260 as shown in FIG. 2B may be able to detect the wake word and a command such as “what is my next appointment,” “what tasks are currently pending today,” or “where did I put my wallet.” In contrast, the remote speech recognition system 260 of FIG. 2A may be able to utilize additional computing power and/or parallel processing to parse more complicated queries and/or speech that is less articulated, including but not limited to accents, foreign languages relative to a default language (e.g., assuming a default language is English), or voice inputs 161 for which an error is generated when trying to recognize parts of speech.

In one or more embodiments, the support server 200 may be writing enabled, that is, permitting the user 102 to provide informational input via writing to one or more input devices, including but not limited to the support hub 201 (e.g., the user 102 may provide input on an instance of that display screen 212 that is a touchscreen, as shown and described in conjunction with the embodiment of FIG. 2B). A writing input data 253 may be forwarded to a writing recognition system 262. The writing recognition system 262 comprises computer readable instructions that when executed on the processor 202 detect one or more words within the writing input data 253 and translate the one or more words into the text translation data 265. The writing recognition system 262 may be based on optical character recognition techniques as may be known in the art. The writing recognition system 262 may be calibrated based on a writing test given to the user 102 when configuring the support server 200. In one or more embodiments, the writing sample obtained by the writing test may also be used to determine which instance of the user 102 generating the writing input data 253 (e.g., determine an associated user ID 280). The writing recognition system 262 may also be provided on a different remote server and/or by a remote software service over the network 101. In such case, the support server 200 may include a remote procedure call (RPC) to the remote instance of the writing recognition system 262. In one or more other embodiments, the writing recognition system 262 may have both local (e.g., on the support hub 201) and remote component specializing in certain aspects of writing recognition.

The text translation data 265 may be parsed to determine the inclusion of one or more events, object placements, object locating requests, reminder requests, recall requests, documentation requests, and documentation awareness alerts and/or requests. For example, the scheduling routine 220 may determine inclusion of one or more events within the text translation data 265. The scheduling routine 220 comprises computer readable instructions that when executed on the processor 202 carry out a number of operations. A first operation receives the text translation data 265 of the user 102. A second operation determines an event is to be defined within the text translation data 265. For example, terms such as “event,” “schedule,” “birthday,” or other associated terms may be recognized. A third operation extracts a date and/or a time from the text translation data 265. A fourth operation generates an event data with the event and/or the time and stores the event data in the events database 222.

The events database 222 may include stored data defining one or more instances of the event data. The event data, for example, may be a jurisdictional event data 224 (e.g., a global awareness day, a national holiday, a state-government closure date, a local holiday), a personal event data 226 (e.g., an appointment of the user 102, a reminder the user 102 set for himself or herself), and/or a group event data 228 (an event in which the two or more instances of the user 102 are invitees, participants, and/or otherwise implicated or involved). Although not shown in the embodiment of FIG. 2, the event data may include a number of attributes such as a start date, an end date, a start time, an end time, one or more participants (e.g., specified by a user ID), one or more associated groups (e.g., specified by a group ID including without limitation email address or chat application ID such as Slack® or Microsoft® Teams), one or more related instances of the event data, a description, a set of contact details (e.g., a dial-in number for a conference call), a location of the event, and/or other information describing or usable in relation to the event.

The scheduling routine 220 may also include computer readable instructions that when executed on the processor 202 determine a request for information from the user 102 stored in the events database 222 and queries the events database 222. For example, if the user 102 asks “what is my schedule tomorrow,” the scheduling routine 220 can execute instructions that determine the current date and add one day, then query the events database 222 for all events, then generate a voice output data 267 and read off the events to the user 102 through the speaker 208. Alternatively or in addition, the scheduling routine 220 could respond to the question of the user 102 by transmitting data for display on the calendar application 216 of the support hub 201 and/or the calendar application 516 of the mobile device 500 to change a view of the display screen 212 and/or the display screen 512, respectively, to expand and/or open the graphical representation of the next days' schedule such that an hour-by-hour view is shown. The calendar application 216 is further shown and described in conjunction with the embodiment of FIG. 2B.

In one or more embodiments, the support server 200 may comprise an object locating engine 230, a recall engine 240, and a spatial documentation engine 250, each of which will now be discussed.

The object locating engine 230 comprises computer readable instructions that when executed on the processor 202 may carry out a number of operations. First, a text translation data 265 of the user may be received, for example from the speech recognition system 260 or the writing recognition system 262. A second operation may extract at least one of an object name, an object description data 237, and/or an object category 239 from the text translation data 265 of the user 102. For example, the user 102 may have said “I am placing the hammer in my truck tool box.” The object name may be determined to be “hammer” and the location may be determined to be “truck of user” and/or “tool box of user.” A category may also be determined of the object and/or storage location, for example by reference to a predetermined and/or custom data table. For example, the hammer may be classified as a “tool.”

In one or more embodiments, a placed object data 231 can be defined through a question-and-answer workflow. For example, the user 102 can say “I am placing an object.” The object locating engine 230 can ask, “Please name the object,” then await the answer of the user 102. The object locating engine 230 can then follow up with “where are you placing the object?,” and await the next answer. And finally, for example, the user 102 can be asked, “please give a brief description of the item or provide a memo”, which the user 102 may then provide and which can be stored as the object description data 237 (abbreviated “Obj. Description Data 237” in FIG. 2A). In one or more other embodiments, the object can be recognized through natural language processing techniques known in the art to determine possible objects as nouns (e.g., tool box, hammer), and distinguish different objects or determining their categories with rules and/or machine learning techniques (e.g., a hammer is a tool; a hammer can go in a toolbox but a toolbox cannot go in a hammer). The user 102 can also be asked to clarify which noun among all identified nouns is the placed object 134 and which may be the location of placement. Similar questions and answer protocols may be used for defining reminders and documentation.

In a third process, a location may be determined and associated with the placed object data 231. For example, a location data 520 may be extracted from a GPS unit 515 of the mobile device 500, as shown and described in FIG. 500, and specifically a coordinate from the location data 520 (e.g., the coordinate 155 of FIG. 1 but in association with a placed object 134). In addition, indoor positioning systems (IPS) via WiFi or other wireless signals may be used for positioning, alone or in conjunction with GPS, to determine location, including but not limited to inside a building. The user 102 may also snap photos which may be analyzed including by an artificial neural network. The photos may also provide backup data for where an object is located (e.g., if an object is not located, the last photo of it may be downloaded to assist in manual location). The location data 520 is stored, possibly in conjunction with other location data, as the object location data 235 of the placed object data 231. A fourth process may then store the placed object data 231 in the object database 232, including optionally storing the user ID 280 of the user 102 placing the object. Although not shown in the embodiment of FIG. 2A, the placed object data 231 can include additional data, such as a start date and/or start time of placement, an end date or end time of placement, a note the user 102 wishes to append to document something (e.g., “this flashlight has a short circuit and uses batteries quickly”, or “do not eat these eggs, I have to make a cake for our guests this weekend”), an owner of the placed object 134, a borrower of the placed object 134, etc. The placed object data 231 may optionally persist in the object database to create a record of where objects are, where they were, and/or which instance of the user 102 placed or moved them. Where the user 102 designates the placed object 134 as belonging to and/or relevant to a group, the user 102 may specify the group (“I am placing the accounting department's stapler in the snack room closet”) and the placed object data 231 may have associated a group ID and the placed object data 231 may then be uploaded to the coordination server 400 and/or transmitted to other instances of the support server 200 and/or the support hub 201 over the network 101.

The user 102 may query the object locating engine 230 verbally, for example by asking “where did I leave my watch?”, or directing a declarative such as “alert me next time I am close to an object I placed.” The object locating engine 230 may query the object database 232 and then transmit data over the network 101 for generating a voice output data 267 and/or a text output data 269 which can be communicated via the speaker 208 or displayed on the display screen 212 of the support hub 201, respectively (and/or the speaker 508 or the display screen 512 of the mobile device 500). Similarly, the voice output data 267 and/or the text output data 269 can be communicated to the wearable device 300.

In one or more embodiments, the object locating engine 230 may comprise an object placement routine 234 and an object locating routine 236. The object placement routine 234 may comprise computer readable instructions that when executed receive an object placement request comprising an object name and optionally an object description data 237 and an object category 239. The computer readable instruction of the object placement routine 234 may, when executed: (i) extracting a coordinate 155 from a location data received from at least one of the mobile device 500 (e.g., the location data 520) of the user 102 and/or from the wearable device 300 of the user 102 (e.g., the location data 320); (ii) store the coordinate 155 extracted from the location data as a coordinate of the object location data 235; and (iii) generate a placed object data 231 comprising a placement ID 233, the object name, the object location data 235, and/or optionally the object description data 237 and the object category 239. The object placement routine 234 may then include computer readable instructions that when executed store the placed object data 231 in the object database 232.

The object locating routine 236 may include computer readable instructions that when executed: (i) receive an object locating request including the object name, the object ID (not shown), and/or a second instance of an object description data; (ii) determine the coordinate 155 of the object location data 235 and/or an area name (not shown) associated with the placed object data 231; and (iii) transmit the coordinate 155 and/or the object location name to the wearable device 300 of the first user 102 and/or the mobile device 500 of the first user 102.

In one or more embodiments, the recall engine 240 may comprise a reminder routine 244, a recall routine 246, and a spatial recall agent 248. The reminder routine 244 may comprise computer readable instructions that when executed receive a reminder request that includes a reminder content data 247 comprising a text file, a voice recording, and/or a video recording. The reminder request may further include a reminder category (not shown), and a user ID 280 of a first user 102 generating the reminder request. The reminder routine 244 may comprise computer readable instructions that when executed generate a reminder condition data 249 that may include one or more conditions, for example a first reminder condition and a second reminder condition of higher urgency than the first reminder condition. As just one example, the first condition may be the expiration of one week, and the second reminder condition may be the expiration of another week. The reminder routine 244 may comprise computer readable instructions that when executed associate within the reminder condition data 249 a first communication medium ID 282 (e.g., an instance of the communication medium ID 282, as shown and abbreviated “Comm. Medium ID 282” in FIG. 2A) with the first reminder condition, and associate a second communication medium ID 282 with the second reminder condition. A communication medium for example may be SMS, IP message (e.g., iMessage®), phone call, a message sent through a mobile application, an email, etc. The communication medium ID 282 may also include a designation of one or more devices to which to communicate.

The reminder routine 244 may comprise computer readable instructions that when executed generate a reminder data 241 comprising a reminder ID 243, the reminder condition data 249 (e.g., comprising the first reminder condition and the second reminder condition), the reminder content data 247, and optionally the user ID 280 of the user 102 generating the reminder request. Although not shown, a user ID 280 of a user to whom the reminder is addressed and/or is to be otherwise provided may also be designated or stored. The reminder routine 244 may then store the reminder data 241, for example in the reminder database 242.

The recall routine 246 may include computer readable instructions that when executed: (i) determine the occurrence of the first reminder condition; (ii) determine the first communication medium ID 282 that is associated with the first reminder condition; and (iii) generate a reminder notification data comprising the reminder content data 247. The recall routine 246 may further include computer readable instructions that when executed transmit the reminder content data 247 through the first communication medium to a wearable device 300 of the user 102, a mobile device 500 of the user 102, and/or a different computer device of the user 102 (e.g., a desktop computer, a laptop, a server). Similarly, the recall routine 246 may determine the occurrence of the second reminder condition of the higher urgency and determine the second communication medium ID 282 that is associated with the second reminder condition. The recall routine 246 may then execute computer readable instructions that re-transmit the reminder notification data through the second communication medium to the wearable device 300 of the user 102, the mobile device 500 of the user 102, and/or the different computer device of the user 102.

In one or more embodiments, a spatial component to the reminder may also be defined. For example, the reminder routine 244 may further include computer readable instructions that when executed: (i) extract a first coordinate 155 from a first location data received from at least one of the wearable device 300 of the user 102 (e.g., the location data 320) and/or the mobile device 500 of the user 102; and (ii) store the first coordinate 155 extracted from the first location data as the first coordinate 155 of a reminder location data 245 within the reminder data 241. A reminder associated with a coordinate 155 may be referred to as a placed reminder 144 (not shown). In combination with the storage of the reminder location data 245, the spatial recall agent 248 comprises computer readable instructions that when executed: (i) determine that a mobile device 500 of the first user 102 and/or the wearable device 300 of the first user 102 is within a threshold distance 156 of the coordinate 155 of the reminder location data 245 (e.g., within one meter, five meters, ten meters, 100 meters). In one or more embodiments, the first reminder condition and the second reminder condition may even be moving within the threshold distance 156 of the first coordinate 155 of the reminder location data 245 (e.g., the first time the user 102 enters an area and the second time the user 102 enters an area).

In one or embodiments, the spatial documentation engine 250 comprises a documentation routine 254, a documentation query routine 256, and a documentation awareness agent 258. The documentation routine 254 may include computer readable instructions that when executed receive a documentation placement request that may include a documentation content data 257 including a text file, a voice recording, and/or a video recording. The documentation placement request may optionally include a documentation name and a documentation category (neither of which are shown in the embodiment of FIG. 2A). The documentation routine 254 may include computer readable instructions that when executed (i) extract a coordinate 155 from a location data received from the mobile device 500 of the first user 102 (e.g., the location data 520) and/or the wearable device 300 of the user 102 (e.g., the location data 320); and (ii) generate a spatial documentation data 251 (shown as the “Spatial Doc. Data 251”) that may include a documentation ID 253, the documentation content data 257, a documentation location data 255 comprising a coordinate 155 of the first location data, the documentation name (not shown), and/or the documentation category (not shown). The documentation routine 254 may then execute instructions to store the coordinate 155 extracted from the second location data as the second coordinate of the documentation location data and store the spatial documentation data 251 (e.g., in the spatial documentation database 252).

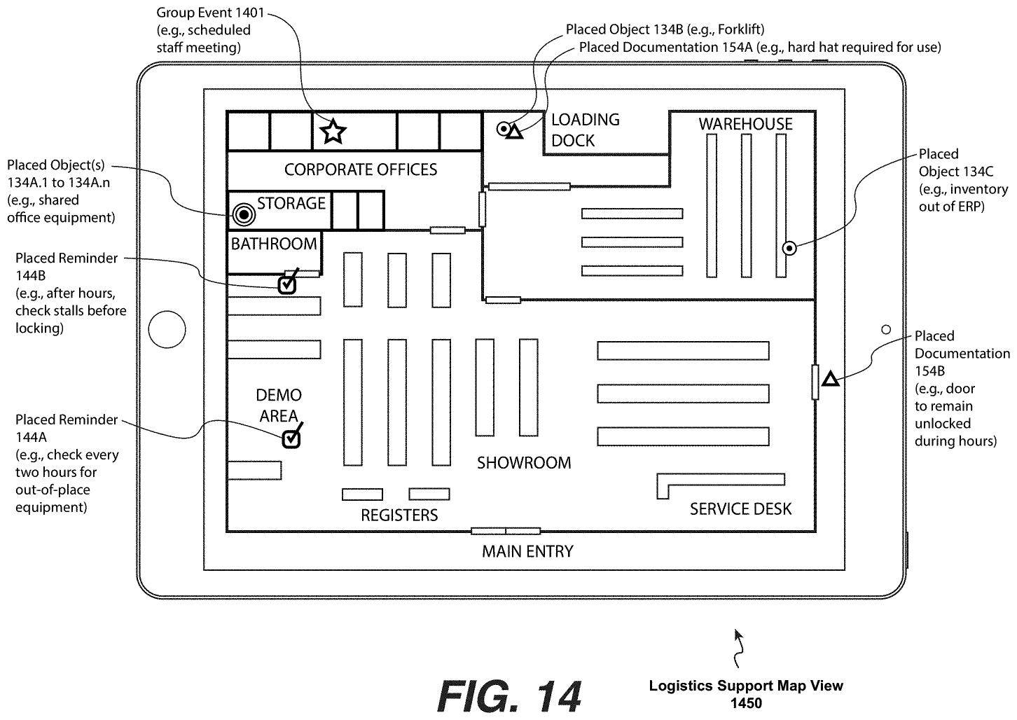

The spatial documentation data 251 may be manually queried, for example after viewing on the display screen 212 of the support hub 201, as shown in FIG. 2B and FIG. 14. In one or more embodiments, the documentation query routine 256 comprises computer readable instructions that when executed: (i) receive a documentation retrieval request comprising the documentation ID 253 from the mobile device 500 of the first user 102 and/or the wearable device 300 of the first user 102; and (ii) transmit the documentation name, the documentation content data 257, and/or the documentation category.

In one or more embodiments, the spatial documentation data 251 may be automatically queried and/or a notification of its availability may be provided to the user 102, including within the context of spatial relevance. In one or more embodiments, the documentation awareness agent 258 comprises computer readable instructions that when executed determine that the mobile device 500 of the first user 102 and/or the wearable device 300 of the first user 102 is within a threshold distance 156 of the coordinate 155 of the documentation location data 255. The documentation awareness agent 258 may further include computer readable instructions that when executed determine an awareness indicator 259 of the spatial documentation data 251 (which may be a default, may be elevated based on importance, and/or may be specified by the user 102 at the time of generating the documentation placement request). In one or more embodiments, the awareness indicator 259 includes data specifying a sound (e.g., cause a ringing sound and/or a “ping” sound on the mobile device 500) and/or a vibration (e.g., cause the mobile device 500 and/or the wearable device 300 to buzz, shake, and/or vibrate). The documentation awareness agent 258 may further include computer readable instructions that when executed transmit an instruction to execute the awareness indicator (e.g., an a documentation awareness notification) on the mobile device 500 of the first user 102 and/or the wearable device 300 of the first user 102.

A machine learning interface 290 may include or more procedures for interfacing with the machine learning server 190. Referring back to FIG. 1, the machine learning server 190 may comprise a machine learning algorithm and an artificial neural network that may be trained to recognize various patterns and associated values, and then may be used to predict the values of similar patterns. For example, the artificial neural network may include two or more nodes each having a function processing inputs to generate weighted outputs. Each node may have one or more of the following functions: receiving input from outside the artificial neural network, receiving a weighted output from another node as an input, passing a weighted output to another node, and/or passing an output outside of the artificial neural network.

In one or more embodiments, the machine learning server may utilize an instance of the artificial neural network for recognizing request types (e.g., an event request, an object placement request, an object locating request, a reminder request, a documentation placement request, and/or a documentation retrieval request). For example, training datasets may include requests which are reviewed and marked (e.g., by human analysis) as a certain request type. In one or more embodiments, the artificial neural network may be used to build a database of information related to room names and associated coordinates 155. For example, users 102 may consistently include a location name within a request while a similar set of coordinates 155 are consistently received from devices of those users 102. Therefore, similar coordinates 155 in future requests may be correlated with the location name, even when the location name is not included in the request. In one or more embodiments, the artificial neural network may be usable to add metadata to the placed object data 231, the reminder data 241, and/or the spatial documentation data 251. For example, the artificial neural network may be trained to recognize an object category based on an object name. This may be especially useful for located placed objects 134. A user 102 may be able to ask “where are the building tools” (e.g., a general category of “building tool” and/or “tool”), and receive from the trained artificial neural network a coordinate showing a hammer stored within a building shed.

FIG. 2B illustrates a support hub 201 which may be a local embodiment of the support server 200, may provide an interface to the support server 200 and/or the coordination server 400, may operate in a peer network with one or more other instance of the support hub 201, and/or may operate independently. Each of the similarly numbered elements in the embodiment of FIG. 2B may operate similarly to such elements shown and described in conjunction with the embodiment of FIG. 2A. However, in one or more embodiments, the support hub 201 may include additional elements that may enable direct interaction and/or user interfaces to the user 102.

The support server 200 may include interfacing elements sufficient for receiving input information from the user 102. For example, the support server 200 may receive input from the user 102 via a microphone 210, through a touchscreen capability of the display screen 212 (including without limitation through use of the pen 215), a physical keyboard, a virtual keyboard displayed on the display screen, and/or through input of another communicatively coupled device (e.g., the mobile device 500).

The camera 207 may be a video camera that can be utilized for recording reminders of the user 102, according to one or more embodiments. For example, the user 102 may direct by voice activation (or press a button) enabling creation of a video or picture memo. In one or more other embodiments, the camera 207 may be able to be used as a third-party reminder or remote accountability method, in which a third party reminds the user 102 to carry out or complete a task or engage in scheduled event.

The support hub 201 may include interfacing elements sufficient for generating output information for the user 102. For example, the support server 200 may generate sound and/or voice output using the speaker 208, may display information visually on the display screen 212, and/or transmit output to additional devices and systems over the network 101 (e.g., the support server 200, the wearable device 300, the coordination server 400, the mobile device 500, the machine learning server 190, and/or other devices and systems).

In one or more embodiments, the support hub 201 may be writing enabled, that is, permitting the user 102 to provide informational input via writing to one or more input devices, including but not limited to the support hub 201. The user 102 may provide input on an instance of that display screen 212 that is a touchscreen.

The calendar application 216 may be provided for convenience and a wholistic approach to logistics for the user 102 and/or the group of users 102. The calendar application 216 may include computer readable instructions for displaying and managing a calendar, including one or more calendar grids 217 for display on the display screen and optionally one or more calendar graphics 218. An example of the calendar grid 217 is illustrated on the display screen 212 of FIG. 2. The calendar graphic 218 may be aesthetically pleasing images of pictures to augment the calendar, as may be present in many paper-based wall calendars. The calendar application 216 may include sizing parameters to adjust the size and/or orientation of the calendar grid 217 and/or the calendar graphic 218. In one or more embodiments, the display screen 212 may be taller than it is wide (e.g., as shown in FIG. 14). For example, it may be desirable to utilize an aspect ratio of 1:2 such that a 12 inch by 12 inch paper wall calendar booklet can be scaled to fit (including one 12 inch by 12 inch portion for the grid and one 12 inch by 12 inch portion for the graphic) on the display screen 212. Such a visual format may provide a familiar interface for the user 102. In one or more other embodiments, and as shown in FIG. 2, the display screen 212 may have an aspect ratio that is wider than it is tall, with the calendar grid 217 displayed over a majority of the display screen 212 surface and the calendar graphic 218 behind the calendar grid 217 and/or on the side or behind the calendar grid 217. The calendar application 216 may further include computer readable instructions that when executed on the processor 202 read the events database 222 and populate the calendar grid 217 with one or more instance of the event data.

In one or more embodiments, in addition or as an alternative means to a wake word, the support hub 201 may have a voice interface activated through use of a physical button in a housing 203 of the support server 200 and/or a graphical button displayed on the display screen 212, where the display screen 212 is a touchscreen. The housing 203 may be made of metal, plastic, or another suitable encapsulating material. Examples of the housing 203 are shown and described in conjunction with the embodiment of FIG. 14, including an example of the physical button.

FIG. 3 illustrates a wearable device 300, according to one or more embodiments. The wearable device 300, in one or more embodiments, comprises a processor 302, a memory 304, and a network interface controller 306. The wearable device 300 includes elements for receiving the input information of the user 102 and/or generating an output information for the user 102. For receiving an input information from the user 102, the wearable device 300 may include a microphone 310 and/or a display screen 312. The wearable device 300 may receive a voice input 161 from the user 102 to generate the voice input data 261. In one or more embodiments, the voice input data 261 may be recorded by the wearable device 300 when the user 102 activates the activation button. The activation button may be a physical button 316 and/or a virtual button 317 displayed on the display screen 312. In one or more embodiments, the user 102 may press the activation button once to record the voice input data 261 for storage on the memory 304. In one or more other embodiments, the user 102 may press and hold the activation button to record the voice input data 261. In one or more other embodiments, the wearable device 300 may detect the voice input 161 of the user 102 (e.g., via a wake word) and then begin recording.

A voice transmission module 318 may read the stored voice input data 261 from the memory 304 and transmit the voice input data 261 through the network 101 to the support server 200 and/or the support hub 201, including without limitation through an instance of the mobile device 500 communicatively “paired” with the wearable device 300 (e.g., through a Bluetooth® or similar connection). In one or more other embodiments, the network interface controller 306 may include a WiFi and/or cellular (e.g., 4G, LTE, 5G) interface capability.

The wearable device 300 may also include computer readable instructions that when executed on the processor 302 receive a notification and/or message from the support server 200 and/or the support hub 201 and communicate the notification and/or message to the user 102. For example, a voice output data 267 (not shown in the embodiment of FIG. 3) may be an answer to a query submitted by the user 102 (e.g., where to find a placed object 134, and/or a documentation content data 257), may remind the user 102 of an impending event (e.g., receive a reminder content data 247), appointment (e.g., an event data), and/or task, or may notify the user 102 that a new group event data 228 has been defined and added to the events database 222. The wearable device 300 may also include a motor for sending vibration notifications, e.g., a mini vibrating motor disk, that can be used to send a notification from the support server 200 and/or the support hub 201. For example, a haptic notification may signify an impending event and/or alert the user 102 to a nearby placed object 134 and/or an awareness indicator 259 responsive to a documentation awareness notification.

In one or more embodiments, if the wearable device 300 includes the display screen 312, the user 102 may interact with the support server 200 and/or the support hub 201 through a graphical user interface. If the screen is relatively small, there may be one or more instances of a command button 319 available on the graphical user interface, for example that requests the next sequential event data to be displayed on the display screen 312 and/or announced on the speaker 308, or requests the documentation content data 257 following a documentation awareness notification. The command button 319, for example, may also return a short menu of placed objects 134 and/or instances of the placed documentation 154 within proximity of the wearable device 300.

The wearable device 300 may also be configured to generate a location data 320 based on WiFi connectivity, use of a GPS unit (not shown in the embodiment of FIG. 2), indoor positioning systems (IPS), cell tower triangulation, 5G ranging, and/or other means known in the art. The location data 320 may be included with the voice input data 261 when communicated back to the support server 200 and/or the support hub 201.

The wearable device 300 may include a fastener 314 for attaching to the human body. The fastener, for instance, may attach to the wrist, finger, arm, ankle, neck, forehead, or other human body part. The wearable device 300 may be, for example, an Apple Watch, an ASUS ZenWatch, Eoncore Eoncore GPS/GSM/Wifi Tracker, a FitBit Blaze, Revolar Instinct device, Ringly Luxe, a Vufine+ Wearable Display, Amazfit Verge Smartwatch, GUESS® Men's Stainless Steel Connect Smart Watch.

FIG. 4 illustrates a coordination server 400, according to one or more embodiments. In one or more embodiments, the coordination server 400 may be a remote computing server serving one or more instances of the support server 200 and/or the support hub 201. The coordination server 400 includes a processor 402 and a memory 404. The coordination server 400 includes one or more databases, including a group database 410, a collective events database 422 that may assist in implementing a shared calendar, and/or a set of collective database 472 storing data of one or more instances of the object database 232, the reminder database 242, and/or the spatial documentation database 252 from one or more instances of the support server 200 and/or the support hub 201. In one or more embodiments, the coordination server 400 and the support server 200 may be implemented together (e.g., on a same physical server, in a same data center, etc.) or may store elements and/or functionality.

The group database 410 defines one or more group profiles which have associated user profiles (e.g., a user profile of the user 102). The group database 410 includes a group ID 412 and one or more associated instances of a user ID 280A through a user ID 280N. Each of the group ID 412 and the user ID 280 may be a unique identifier (e.g., an email address, a phone number, a user name) and/or a globally unique identifier (e.g., a random alphanumeric string). In turn, each user ID 280 may be associated with a known instance of the support hub 201 and/or support server 200, for example through a device ID such as a MAC address, IP address, or other identifier.

The collective events database 422 includes a group event data 228, which may include any of the data specified for an event data, as shown and described in conjunction with FIG. 1, FIG. 2A, and FIG. 2B, and may also include the group ID 412 usable to determine which user ID 280s, device IDs, and therefore which instance(s) of the support hub 201 should receive the group event data 228 for addition to the events database 222. In a specific example, the user 102 may define an event data that, upon designation for a group (and selection of the group which may assign the group ID 412), is stored as the group event data 228 on a support hub 201A. The group event data 228 is then transmitted to the coordination server 400 over the network 101. The coordination server 400 may receive the group event data 228, store the group event data 228 in the collective events database 422, lookup all instances of the user ID 280 associated with the group ID 412, and transmit the group event data 228 to be stored in the event database 222 of additional instances of the support hub 201 associated with the group (e.g., a support hub 201B).

The collective memory engine 470 includes computer readable instructions that manage the content, queries, and/or the permissions of the collective database 472. The collective database 472 may include data from the object database 232, the reminder database 242, and/or the spatial documentation database 252. For example, a placed object data 231 may further include the group ID 412 of a group which may query and/or otherwise have access to the data of the placed object data 231. The reminder data 241 and/or the spatial documentation data 251 may also include an associated instance of the group ID 412. Alternatively or in addition, a different user ID 280 may be defined to have access (for example, a user 102A associated with the user ID 280A defines a spatial documentation data 251 that is viewable by a user 102B associated with the user ID 280B). The reminder data 241 may further have a designated recipient user 102 (“addressee”), or a user 102 and/or group of users 102 to whom the reminder is addressed. The reminder data 241 may also have differing users depending on a triggered condition, for example within a business context a first reminder going to a lower-level manager and a second reminder going to a higher-level manager. Placed object data 231 from one or more object databases 232 may be designated for a group. New instances of a placed object data 231 accessible by a group may be defined, uploaded to the coordination server 400, and distributed similarly to a new event of the group event data 228.

The coordination server 400 may include an authentication system 406 and/or an authorization system 408. The authentication system 406 authenticates one or more users 102 requesting access to the data of the collective events database 422 and/or the collective database 472. Techniques known in the art of computing and cybersecurity may be used, such as two factor authentication. The authorization system 408 may determine whether a user 102 has sufficient permission to query, read, write, or otherwise interface with data stored in the collective database(s) 472. For example, a user 102 may have authorization to read from the documentation content data 257 of a spatial documentation data 251, but not to write to it. In another example, the user 102 may have the authority to receive a documentation awareness notification (e.g., such that the user 102 knows documentation is available), but not to request the associated documentation content data 257 without permission. Such permission may be requested through a message sent to an appropriate administrative user, including for example through the support server 200 and/or the support hub 201.

The coordination server 400 may include the speech recognition system 450 and the writing recognition system 452, as shown and described in conjunction with FIG. 2A. However, the coordination server 400 may be able to support more robust, powerful, and fast versions of the speech recognition system 450 and/or the writing recognition system 452 where the coordination server 400 may be a relatively powerful server computer (e.g., located in a data center) or otherwise have significant computing resources, according to one or more embodiments. The coordination server 400 may also optionally provide data backup and recovery for any communicatively coupled instance of the support server 200 and/or support hub 201.

In one or more other embodiments, where two or more instances of the support hub 201 and/or the support server 200 are networked, functions of the coordination server 400 (including but not limited storage of the group database 410 and/or the collective database 472) may be carried out by a designated instance of the support hub 201 as a master node.

For purposes of the following description, a first user 102A may have defined data in the collective database 472, and a second user 102B may be the recipient and/or beneficiary of the data. In one or more embodiments, the collective memory engine 470 comprises computer readable instructions that when executed: (i) determine the user 102B is associated with the group ID 412 and/or otherwise has authorization; (ii) determine the occurrence of the reminder condition (e.g., of the reminder condition data 249); (iii) determine the first communication medium ID 282 that is associated with the first reminder condition; (iv) generate a reminder notification data that includes the reminder content data 247; and (v) transmits the reminder content data 247 through the first communication medium to a wearable device 300 of the user 102B, a mobile device 500 of the user 102B, and/or a different computer device of the user 102B. In one or more embodiments, the collective memory engine 470 comprises computer readable instructions that when executed: (i) determine the user 102B is associated with the group ID 412 and/or otherwise has authorization; (ii) determine that the mobile device 500 of the user 102B and/or the wearable device 300 of the user 102B is within the threshold distance of the coordinate 155 of a documentation location data 255; (iii) determine the awareness indicator 259 of the spatial documentation data 251; and (iv) transmit the instruction to execute the awareness indicator 259 on the mobile device 500 of the user 102B and/or the wearable device 300 of the user 102B.

In one or more embodiments, the collective memory engine 470 comprises computer readable instructions that when executed: (i) determine the user 102B is associated with the group ID and/or otherwise has authorization; (ii) receive a documentation retrieval request including the documentation ID 253 from the mobile device 500 of the user 102B and/or the wearable device 300 of the second user 102B; and (iii) transmit the documentation name, the documentation content data 257, and/or the documentation category to the mobile device 500 of the user 102B and the wearable device 300 of the second user 102B.

In one or more embodiments, the collective memory engine 470 comprises computer readable instructions that when executed: (i) determine the user 102B is associated with the group ID and/or otherwise has authorization; (ii) receive an object locating request including the object name, the placement ID 233, and/or the object description data 237 from the wearable device 300 of the user 102B and the mobile device 500 of the user 102B; (iii) determine the coordinate 155 of the object location data 235 and an area name associated with the object location data 235; and (iv) transmit the coordinate 155 and/or the area name to the wearable device 300 of the user 102B and the mobile device 500 of the second user 102B. The reminder request and/or the reminder data 241 may include a user ID 280 of a user 102B to which the reminder content data 247 is addressed.

FIG. 5 illustrates a mobile device 500, according to one or more embodiments. The mobile device 500 may include a processor 502, a memory 504, a network interface controller 506, a camera 507, a speaker 508, a microphone 510, and/or a display screen 512. The mobile device 500 may also include a GPS unit 515 for determining a geospatial coordination to generate the location data 520. The mobile device 500 may be a smartphone or tablet, for example, an iPhone, an Android® phone, an iPad, a Samsung® Galaxy device, a Microsoft® Surface, a Surface Duo, an Amazon® Kindle, and other similar devices.

The mobile device 500 can carry out many of the functions of the wearable device 300 of FIG. 3, possibly with some additional capability that may or may not be possible with the wearable device 300. For example, the mobile device 500 can include the calendar application 516 for display of the calendar grid 217 populated with event data that may be queried from the events database 222 on the support hub 201 trough the network 101. The mobile device 500 may also include a mapping application 517 which may comprising compute readable instructions that when executed receive location data and/or coordinates from the support server 200 and/or the support hub 201 and, as illustrated in the present embodiment and the embodiment of FIG. 14, plot the coordinates on a map displayable on the display screen 512. The mobile device 500 can also include an instance of the speech recognition system 260, the writing recognition system 262, and/or may communicate directly with the coordination server 400.

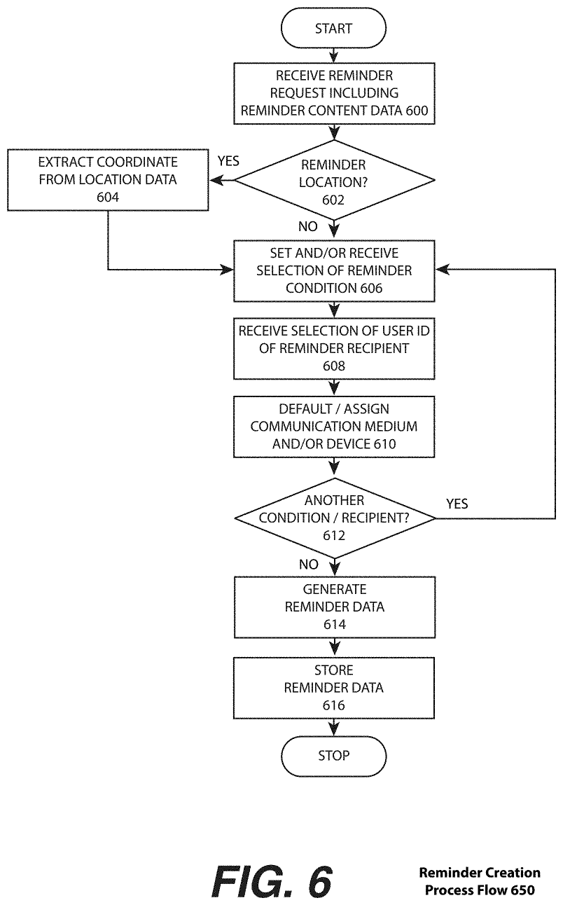

FIG. 6 illustrates a reminder creation process flow 650, according to one or more embodiments. Operation 600 receives a reminder request including a reminder content data 247. For example, the reminder content data 247 may include a text file (e.g., a user 102 typing a reminder), an audio recording (e.g., the user 102 recording a verbal reminder), and/or a video file (e.g., the user 102 recording a video reminder). Operation 602 determines whether a location is associated with the reminder. Where a location is to be associated with the reminder, operation 604 may extract a coordinate 155 from a location data (e.g., the location data 320 and/or the location data 520). Alternatively, or in addition, the user 102 may include as part of the reminder request, or later be prompted for, a location at which the user 102 is not presently located. Operation 606 sets and/or receives a selection of a reminder condition. For example, the reminder condition may be temporal (based on expiration of time), may be geographical (e.g., based on moving within a geofence), may relate to actions of one or more other users (e.g., a different user 102 moving within a geofence), and/or may be an arbitrary number of other definable conditions, including those which may be triggered by data received from third-party APIs. Operation 608 receives a selection of a user ID 280 for which the reminder is intended, e.g., a recipient. For example, the reminder content data 247 may include a reminder to the user 102 generating the reminder, a different user, and/or a group of users.

Operation 610 determines a communication medium (e.g., call, email, text, push notification) and/or device (e.g., the mobile device 500, the support hub 201 of a user 102) to assign to a reminder notification. For example, the determination of operation 610 may be designated and stored as the communication medium ID 282. Operation 612 determines whether another condition and/or recipient should be set. If another condition and/or recipient should be set, operation 612 returns to operation 606. Otherwise, operation 612 proceeds to operation 614. Operation 614 generates a reminder data 641, for example including one or more of the elements illustrated in the embodiment of FIG. 2A. Operation 616 may then store the reminder data 641, for example in the reminder database 242 and/or the collective database 472 (including in association with one or more group IDs 412 and/or permissions).

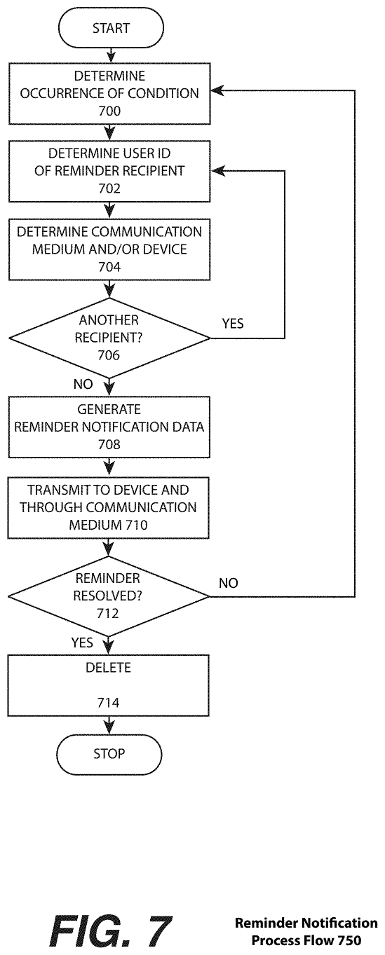

FIG. 7 illustrates a reminder notification process flow 750, according to one or more embodiments. Operation 700 determines occurrence of a condition, for example as specified in the reminder condition data 249. The condition may be based on a spatial event, receipt of information from a third-party API or independent IT system (e.g., Salesforce®, ERP software, etc.), and/or actions taken by one or more other users 102. Operation 702 determines a user ID 280 of a user 102 who is to be a recipient of the reminder. The user ID 280 may be stored on the reminder data 241, may be implied (e.g., when an instance of the support hub 201 serves only one person), or may be otherwise determined. Operation 704 determines a communication medium and/or device for transmitting a reminder notification data (e.g., the mobile device 500, the wearable device 300, a different computing device). The communication medium and/or such “target device” may be specified by one or more instances of a communication medium ID 282 associated with the reminder condition data 249. Operation 706 determines whether another recipient is specified, in which case operation 706 returns to operation 702. Otherwise, operation 706 proceeds to operation 708.

Operation 708 generates a reminder notification data. The reminder notification data may include data extracted from the reminder database 242 and/or the reminder data 241. For example, the reminder notification data may include a reminder location data 245 (including any associated coordinate 155), a reminder content data 247, and/or a user ID 280 (e.g., of a user 102 setting the reminder). Operation 710 transmits the reminder notification data to the target device(s) specified in operation 704 and through the specified communication medium(s). It should be noted that the reminder notification data may be sent to multiple instances of the user 102, sometimes on different devices and/or through different communication mediums. For example, a primarily responsible user 102A may receive a voice recording of a reminder from their manager sent to both the user 102A's mobile device 500 and their email, while a user 102B that is the manager may simultaneously receive just an email. Operation 712 determines if the reminder is resolved. For example, the user 102 may select to “reply” that the subject matter of the reminder has already been addressed, “snooze” the reminder, re-assign the reminder to a different user 102, or indicate the reminder is moot or no longer relevant. If the reminder is not resolved, operation 712 may retain the reminder data 241 in the reminder database 242, and operation 712 may return to operation 700. If the reminder is resolved, operation 712 may proceed to operation 714 which may delete the associated reminder data 241 or mark the reminder data 241 as resolved (e.g., such that future reminders may not be sent out and/or a location of the reminder is not displayed on a map).

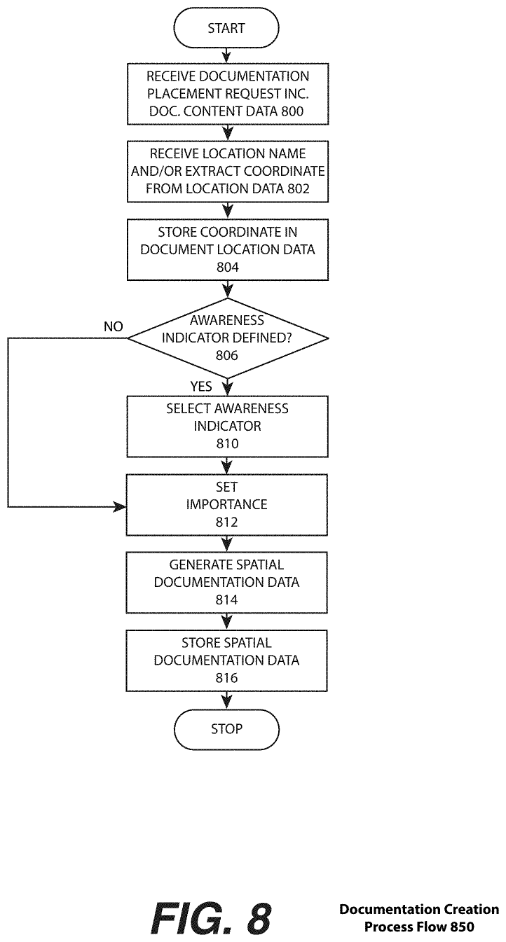

FIG. 8 illustrates a documentation creation process flow 850, according to one or more embodiments. Operation 800 receives a documentation placement request including a documentation content data 257. The documentation content data 257, for example, may be a text file, an audio recording, and/or a video recording. Operation 802 receives a location name and/or extracts a coordinate 155 from a location data (e.g., the location data 320, the location data 520). The location name may be associated with one or more coordinates in a database, for example as may be stored on the support server 200 and/or the support hub 201. For example, a learned and/or predetermined list of relevant locations to the use may be set up ahead of time, which may associate rooms of a house or areas of an industrial facility with one or more coordinates.

Operation 804 may store the coordinate in a documentation location data 255, including any coordinate determined from the location name. Operation 806 determines whether an awareness indicator is to be defined. The awareness indicator, for example, may involve a passive monitoring process that indicates and/or notifies a user 102 of the availability of documentation upon a condition. The awareness indicator may therefore increase the probability that documentation that may be relevant to the user is presented in context. If no awareness indicator is to be defined, operation 806 may proceed to operation 814. However, if an awareness indicator is to be selected, operation 808 proceeds to operation 810, which selects an awareness indicator (e.g., from an available list). For example, the awareness indicator may be to initiate a vibration and/or sound on a device of a user, e.g., send a push notification to the mobile device 500. The awareness indicator may be stored as the awareness indicator 259.

Operation 812 may receive a selection of an importance level of the documentation. For example, certain pieces of documentation may relate to convenience or preference of family and/or coworkers (e.g., “please take off your shoes even when entering the laundry room”), whereas others may related to health and safety (e.g., “Warning: always ensure the pressure gage is below 400 psi before initiating the transfer of liquid nitrogen into the holding tank or severe injury could result”). The importance level may also change and/or determine the awareness indicator. Operation 814 generates a spatial documentation data 251, including for example storing any of the data as shown and described in conjunction with the embodiment of FIG. 2A. Operation 816 may then store the spatial documentation data 251, for example in a spatial documentation database 252.

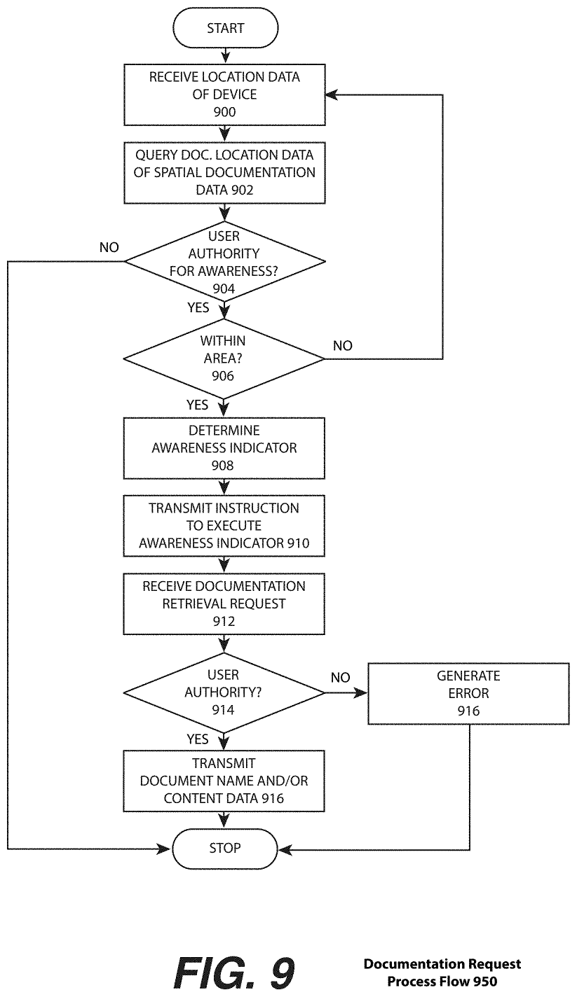

FIG. 9 illustrates a documentation request process flow 950, according to one or more embodiments. Operation 900 receives a location data from a device (e.g., the location data 320, the location data 520). For example, operation 900 may be implemented with a software agent that periodically receives the location data, and/or a process running on the device may be aware of a number of downloaded instances of the coordinate 155, the proximity to which initiates transmission of the location data of the device (e.g., the location data 320, the location data 520). Operation 902 queries the documentation location data 255 of one or more instances of the spatial documentation data 251. In one or more embodiments, an index of all current coordinates 155 and/or location data (including without limitation the object location data 235, the reminder location data 245, and/or the documentation location data 255) may be set up to enhance query efficiency. Operation 902 may therefore determine a relevant instance of the spatial documentation data 251. Operation 904 determines whether the user 102 has an authority to receive a documentation awareness notification, e.g., that the documentation is available to be viewed and/or requested. If not, operation 904 may proceed to terminate. Otherwise, operation 904 may advance to operation 906. Operation 906 determines whether the user 102 is within the area defined in the documentation location data 255, for example, a mobile device 500 of the user 102 determined to be within a geofence and/or within a threshold distance 156 of a coordinate 155 stored in the documentation location data 255. If the user 102 is determined to not within the area, operation 906 returns to operation 900. Otherwise, if the user 102 is determined to be within the area, operation 906 proceeds to operation 908.

Operation 908 determines an awareness indicator 259, for example the awareness indicator set in operation 810 of FIG. 8. Operation 910 transmits an instruction to execute the awareness indicator, which may be referred to as a documentation awareness notification, for example on the mobile device 500, the wearable device 300, and/or a different computing device. The user 102 may take a variety of actions in response, for example dismissing the documentation awareness notification or requesting the documentation. Operation 912 receives the documentation retrieval request (e.g., the user 102 requests to download and/or view the documentation). Operation 914 then determines whether the user 102 has authority to view the complete documentation. In one or more embodiments, there may be a separation in authority between awareness of documentation and actual viewing and/or use of the documentation. For example, the user 102 may need to ask for permission to view the documentation. If the user 102 does not have authority, operation 914 may proceed to operation 916 which may generate an error which may be delivered to a device of the user 102. If the user 102 does have authority, operation 914 proceeds to operation 916 which transmits the documentation content data 257 (and/or other data of the spatial documentation data 251 to the user 102).

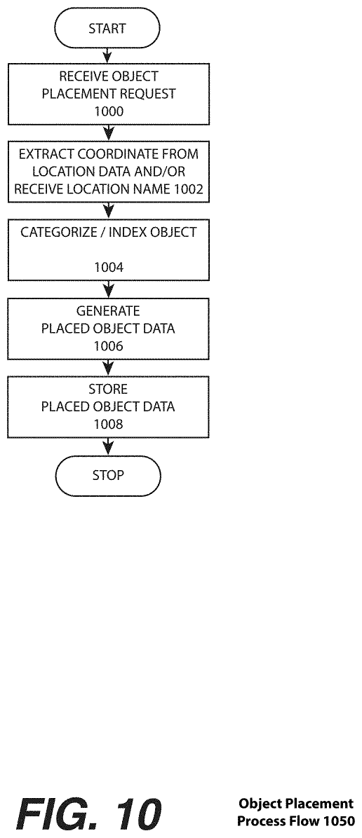

FIG. 10 illustrates an object placement process flow 1050, according to one or more embodiments. Operation 1000 receives an object placement request, for example generated by the mobile device 500, the wearable device 300, and/or a different device. In one or more embodiments, each object may have an attachable locating device, for example enabled with WiFi connectivity, which may also be used to locate the object. Operation 1002 extracts a coordinate 155 from a location data (e.g., the location data 320, the location data 520) and/or receives a location name that may be associated with one or more coordinates in a database. Operation 1005 may then categorize the placed object 134 (e.g., based on machine learning techniques to recognizing a name of an object as a class and/or type, and/or based on a predetermined or template taxonomy). Operation 1004 may then index the placed object 134 and/or its location. Operation 1006 generates a placed object data 231, and operation 1008 may then store the placed object data 231 in a computer memory and/or computer storage, for example within the object database 232.

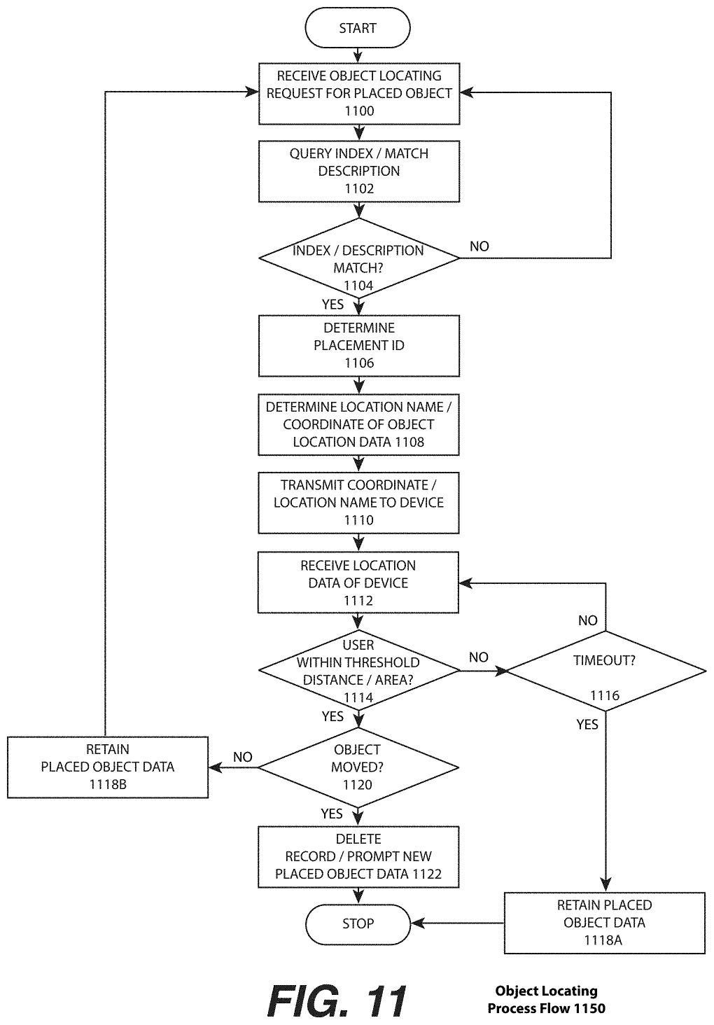

FIG. 11 illustrates an object locating process flow 1150, according to one or more embodiments. Operation 1100 receives an object locating request, for example from a user 102. The object locating request may include the object name, the object category, an object identifier, an object description, and/or other data sufficient to identify the placed object 134. The object locating request may originate from one of a number of sources, for example the wearable device 300, the mobile device 500, the support hub 201, and/or other computing devices. In one or more embodiments, operation 1102 queries the index and/or matches a description of the object to one or more object descriptions. For example, a description of the object received in the object locating request may be parsed and utilized in a natural language search of the object description data 237 of one or more instances of the placed object data 231. A similar search may be conducted for an object name, and object category, and/or other attributes or identifying information. Operation 1104 determines whether a match occurs in the query of operation 1102. Where a match does not occur, operation 1104 may return to operation 1100, and/or request additional information from the user 102 which may help further narrow down or identify the placed object 134 that the user 102 may be searching for. Otherwise, if a match is determined, operation 1104 proceeds to operation 1106.

Operation 1106 determines the placement ID 233, for example as determined from the index determined in operation 1102. It should be noted that the placement ID 233 may, alone or more embodiments, represent an identifier of the particular “placement” of the placed object 134, rather than an identifier of the placed object 134 itself. In one or more embodiments, the object may also have its own unique identifier which may be assigned and/or predetermined (e.g., an object ID, not shown in the embodiment of FIG. 2A). Operation 1008 determines a coordinate 155 of the object location data 235, for example by reading the object location data 235. Operation 1010 may then transmit the coordinate 155 and/or an associated location name to the device of the user, for example the mobile device 500, and/or the wearable device 300. In one or more embodiments, the operation 1010 may end (not shown), and the user 102 may manually go to find the placed object 134 and may be responsible for updated the location of the object with a new object placement request that may define a new placed object data 231.

Operation 1012 may receive location data of a device, for example the mobile device 500 and/or the wearable device 300. A coordinate 155 may be extracted from the location data. Operation 1114 determines whether the user 102 is within a threshold distance 156 of the placed object 134 and/or a defined area of the placed object 134, as may be determined from a location data of the device of the user 102. If the user 102 is not within the area, operation 1114 may proceed to operation 1116 which may determine whether a timer has expired. For example, the timer may have been set in association with the execution of operation 1110. If the timer has not expired, operation 1116 may return to operation 1114. Otherwise, if the timer has expired (e.g., a timeout), it may be inferred that the user 102 is no longer searching for the placed object 134 and operation 1116 may proceed to operation 1118A, which retains the placed object data 231, for example in the object database 232.

If the user 102 is within the area as determined in operation 1014, operation 1014 proceeds to operation 1120. Operation 1120 may determine if the placed object 134 was moved, including prompting the user 102 to provide information. In one or more embodiments, if the user 102 is determined to be proximate to the placed object 134 following a locating request in operation 1100, it may be assumed the user 102 found the placed object 134. If the placed object 134 has not been moved, as such information may be requested from the user 102 and/or automatically determined, operation 1120 may proceed to operation 1118B which retains the placed object data 231. If the placed object 134 has been determined to have moved (or is assumed to have moved), operation 1120 may proceed to operation 1122, which may delete and/or archive the placed object data 231 and/or prompt the user 102 to define a new placed object data 231.

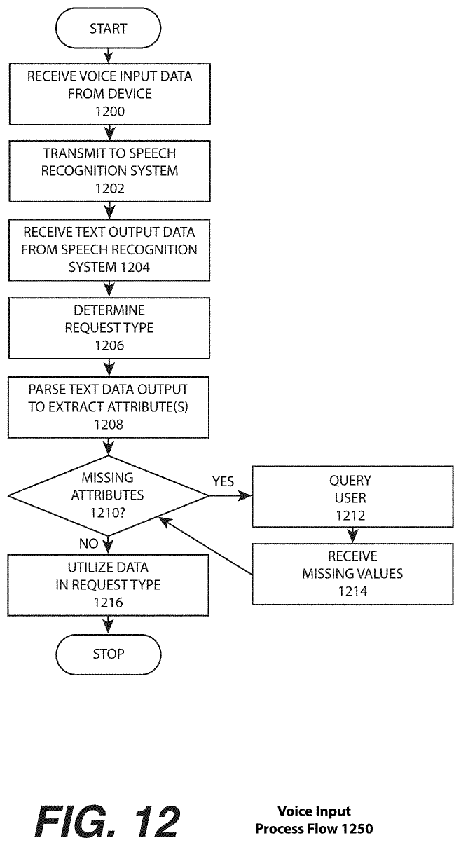

FIG. 12 illustrates a voice input process flow 1250, according to one or more embodiments. The voice input process flow 1250 may be usable with any of the processes described herein such as the scheduling routine 220, the object locating engine 230, the recall engine 240, and/or the spatial documentation engine 250. For example, the voice input process flow 1250 may be useful in generating the object placement request, the object locating request, the reminder request, the documentation placement request, and/or the documentation retrieval request. Operation 1200 receives a voice input data 261 from a device, for example a data recording generated of the voice input 161 generated by the support hub 201, the wearable device 300, and/or the mobile device 500. The voice input data 261 may also be generated from an audio portion of a video file. Operation 1202 transmits the voice input data 261 to a speech recognition system (e.g., the speech recognition system 260 of FIG. 2A, FIG. 2B, and/or FIG. 4. Operation 1204 receives a text output data 269 from the speech recognition system 260. Operation 1206 determines a request type, for example the object placement request, the object locating request, the reminder request, the documentation placement request, and/or the documentation retrieval request. The request type may be identified from the text output data 269 (e.g., identification of the word “document” or “reminder” within the text output data 269), or may have been specified at the time of receipt of the voice input data 261 (e.g., the user 102 held down a button that said “record documentation” on a user interface of the mobile device 500). Operation 1208 parses the text output data 269 to extract one or more attributes relevant to the request type, for example: a location name, an object description data 237, an object category 239, a reminder content data 247, a reminder condition, a communication medium 282, a documentation content data 257, an awareness indicator 259, a recipient of a reminder, a permission associated with a user and/or a group, etc. Machine learning techniques known described herein and as may be in the art may be utilized to improve the parsing, recognition, and/or extraction of each of the attributes and associated values in operation 1208.

Operation 1210 determines whether any attributes of the request are missing. For example, for defining an event data, operation 1210 may determine missing attributes of a placed object data 231, a reminder data 241, and/or a spatial documentation data 251 (and/or any necessary or highly desirable missing attributes, as may be predetermined). Where the request type is the retrieval of information, operation 1210 may determine if enough information has been obtained for a match against an index and/or whether a close match is obtained to one or more existing instances of the event data, the placed object data 231, the reminder data 241, and/or the spatial documentation data 251. Natural language search may also be used in this process. Operation 1210 then proceeds to operation 1212 which may query the user 102 (e.g., send a request for the additional values of the empty attributes) on the device of the user 102. Operation 1214 may then receive the missing values (or an attempt to submit the missing values) and return to operation 1210 to undergo another completeness evaluation. Once no missing attributes are determined, operation 1210 may proceed to operation 1216 which may utilize the data parsed from the text output data 269 in the request type.

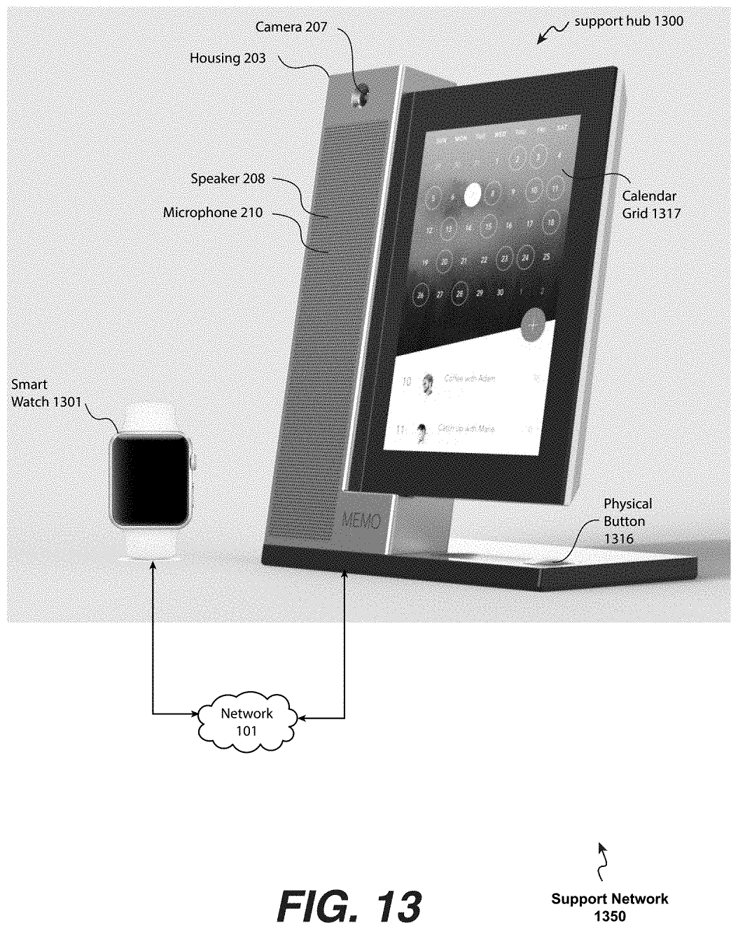

FIG. 13 illustrates a support network 1350, for example for use in an office environment, according to one or more embodiments. The support hub 1300 illustrates an instance of the support hub 201 as illustrated in the embodiment of FIG. 2B. The support hub 1300 is connected to a smart watch 1301 (e.g., an instance of the wearable device 300 of FIG. 3) through the network 101 which may include WiFi, ethernet, 5G, etc. The support hub 1300 is illustrated displaying a stylized instance of the calendar grid 217 including a lower region for displaying a next two impending events, specifically an event data 1324A and an event data 1324B in the embodiment of FIG. 13. The support hub 1300 includes a physical button 1316 that may be utilized rather than a wake word for voice activation (e.g., to initiate recording of the voice input data 261), similar to the physical button 316 shown and described in the embodiment of FIG. 3. The user interface may be easily switchable to a map view, for example by quickly pressing the physical button 316 (versus holding the physical button 316 to being recording the voice input 161). A mapping application may query the object database 232, the reminder database 242, and/or the spatial documentation database 252 to plot one or more locations associated with various reminders, placed documentations 154, and placed objects 134 on a map, as shown and described in conjunction with FIG. 14.

FIG. 14 is a logistics support map view 1450, according to one or more embodiments. The logistics support map view 1450 may illustrate use of the support server 200, the support hub 201, and/or one or more other aspects of the support network 100, according to one or more embodiments. In the embodiment of FIG. 14, a map of a business location and/or facility that may be a retail store is illustrated, with one or more areas indicated in capital letters. A number of users 102 may be associated with the business, for example janitorial personnel, warehouse personnel, floor personnel, and corporate managers, each of which may have one or more instances of a device (e.g., the wearable device 300, the mobile device 500). Each of the users 102 may define events, reminders, place documentation, and/or record placed objects 134 which may be relevant to one or more of the users 102.

Each of several examples will now be described. The examples are each plotted on a map of the business location and viewable on a tablet device (e.g., an instance of the mobile device 500) as if from an administrator's point of view (e.g., having permission and/or authority to view all information with databases). The tablet device may communicate through a local WiFi network or other network to the support hub 201 (e.g., located in the corporate offices), the support server 200 (e.g., located off-site), and/or the coordination server 400 (e.g., located off-site).

First, a set of placed objects 134, shown as the placed object 134A.1 through placed object 134A.n, may have been stored in a storage closet. The mapping application 517 plotting on the map and/or the user interface may group several geospatial points together, which can be expanded when the user 102 selects the grouped point on the touchscreen. The list of the placed object 134A.1 through the placed object 134A.n may be available to all employees (e.g., in case a piece of equipment may be needed in the main showroom), but the location may only be viewable by instances of the user 102 that are corporate personnel. A placed object 134B may be associated with a forklift. Unlike some instances of the placed object 134, the forklift may have installed a small device communicatively coupled over the network 101 (e.g., WiFi) to determine its whereabouts in real time, for example updating a corresponding instance of the object description data 237 of the placed object data 231 (and/or modeling the forklift as a permanent object with an Object ID). All employees may have an awareness of the location of the forklift, and may, for example, be notified if the forklift approaches a door between the warehouse and the showroom (e.g., to prepare employees for ensuring customers are out of the way).

A placed object 134C may be a set of inventory that is incorrectly listed in an enterprise resource planning (ERP) software of the business. For example, for logistical reasons the business may have temporarily moved inventory from one location in the warehouse where in normally should be located into a different area of the warehouse. A user 102 who is a warehouse personnel may have quickly provided a voice input 161 on a wearable device 300, for example: “I am placing a palette of our flat screen televisions in isle six of the warehouse so we have room to process our next shipment.” The voice input 161 may be processed through speech recognition (e.g., via the speech recognition system 260) and result in generation of the placed object data 231.

A placed documentation 154A may be appended to the placed object 134, e.g., such that the documentation location data 255 is updated with motion of the forklift. The placed documentation data 154 may have an awareness condition that any user 102 within a threshold distance of 5 meters is informed that are to be wearing a hard-hat, per regulatory requirements. In contrast, the placed documentation 154B may have no awareness condition defined, but rather document that a certain side-door is to remain unlocked during business hours per a city ordinance. The documentation of 154B, for example, may be available to janitorial staff, including new instance of the user 102 who are in training.

A placed reminder 144A may be associated with a location in a demonstration (“demo”) area. The placed reminder 144A may remind any employee walking by the demo area to check for out-of-place inventory or demonstration floor models that customers may be able to test, for example so to ensure they are not left where other customers could trip over or break them.

The reminder may be given at most once every two hours to up to one employee (e.g., a reminder condition) so that every employee is not reminded every time they walk by. The placed reminder 144B that may apply to janitorial personnel only. The placed reminder 144B may be a reminder that the bathroom stalls are to be checked before locking the bathroom. The placed reminder 144B may only be active for a several hour period following normal store hours (e.g., 7 PM to 9 PM), e.g., an example of a reminder condition that may be stored in a reminder condition data 249. The reminder may be especially important in the present example because a different location of the business may have accidentally locked a customer in the bathroom once, and wants to take great care that it does not happen again at this location. Therefore, a second reminder condition may send a message at 8 PM reminding the janitorial personnel to check the stalls.

Additional reminders may have no associated plot point on the map. For example, a reminder may be triggered when a message from an API of a shipping company is received that a shipment is incoming. The reminder content data 247 may include a short video instructing employees to check a back alleyway for obstructions, including pointing out several locations which should be checked but which are otherwise difficult to see from the loading dock.

Finally, one or more upcoming events may be displayed if associated with a location. The group event 1401 may be defined in a conference room for store personnel and corporate manages, for example a team meeting to prepare for an upcoming store-wide sale.

At first the users 102 may be asked to provide additional information along with their object placement requests, object locating requests, reminder requests, documentation placement requests, and/or documentation retrieval request. However, over time, a database may be developed associating the various locations with their location names, and assisting in categorizing and classifying commonly used objects. The support hub 201 and/or the support server 200 may get increasingly easy, fast, and accurate over time.

As a result of use of one or more aspects of the support network 100 and/or the support server 200, the business may have been able to increase efficiency, saving money and time. Objects may not be as easily misplaced or needlessly re-ordered when incorrectly thought to be lost. Important documentation has been recorded to increase the consistency, allow for cross-functional roles within the organization (e.g., corporate staff closing up the store if necessary), and even to improve the safety of staff and customers.

Although the present embodiments have been described with reference to specific example embodiments, it will be evident that various modifications and changes may be made to these embodiments without departing from the broader spirit and scope of the various embodiments. For example, the various devices, engines and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., the support server 200, the support hub 201, the wearable device 300, the coordination server 400, the mobile device 500). Accordingly, the specification and drawings are to be regarded in an illustrative rather than a restrictive sense.

The structures in the figures such as the engines, routines, and modules may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

What is claimed is:

1. A personal and/or team logistics support system comprising:
a support hub comprising:
a processor of the support hub,
a memory of the support hub,
a network interface controller of the support hub,
a display screen of the support hub,
a calendar application comprising one or more calendar grids for display on the display screen,
a reminder database storing a reminder data comprising, at least one of a reminder ID, a reminder name, a reminder condition data, a reminder content data comprising at least one of a text file of a reminder, a voice recording of the reminder, and a video recording of the reminder, a reminder category, a user ID of a first user defining the reminder, and a reminder location data;
at least one of a voice recognition system and a remote procedure call to the voice recognition system, the voice recognition system receiving a voice input of a first user and generating a text output,
a reminder routine comprising computer readable instructions that when executed on the processor of the support hub:
receive the text output of the first user;
extract a reminder content data and a reminder condition from the text output; and
record the reminder data in the reminder database, and
a housing storing the processor of the support hub, the memory of the support hub, the network interface controller of the support hub, and in which the display screen of the support hub is set, and
a wearable device of the first user, comprising:
a processor of the wearable device,
a network interface controller of the wearable device,
a display screen of the wearable device,
an activation button of the wearable device that is at least one of a virtual button and a physical button, and
a voice transmission routine of the wearable device comprising computer readable instructions that when executed on the processor of the wearable device:
determine activation of the activation button;
record the voice input of the first user; and
transmit the voice input to the support hub, and
a network communicatively coupling the support hub and the wearable device of the first user.

2. The system of claim 1, further comprising:
a mobile device of the first user, comprising:
a processor of the mobile device,
a memory of the mobile device, and
a voice transmission routine of the mobile device comprising computer readable instructions that when executed on the processor of the mobile device:
record the voice input of the first user; and
transmit the voice input to the support hub, and
a GPS unit.

3. The system of claim 2, wherein the support hub comprising:
an object database storing a placed object data having an object name and at least one of an object location data, an object description data, an object category, and a user ID of the first user;
an object locating engine comprising computer readable instructions that when executed on the processor of the support hub:
receive a second text output of the first user;
extract at least one of the object name, the object description, and the object category from the second text output of the first user;
extract a coordinate of the object location data from a location data received from the mobile device; and
record the placed object data in the object database.

4. The system of claim 3, further comprising:
a coordination server, comprising:
a processor of the coordination server,
a memory of the coordination server,
a collective reminder database,
a collective memory engine comprising computer readable instructions that when executed on the processor of the coordination server:
receive a second reminder data and a group ID from the first user, wherein the first user is associated with the group ID;
store the second reminder data in the collective reminder database;
lookup a second user associated with the group ID; and
deliver the reminder data to a second support hub of the second user.

5. The system of claim 4, the coordination server further comprising:
a collective object database, wherein
the collective memory engine comprising computer readable instructions that when executed on the processor of the coordination server:
receive a second placed object data and the group ID from the first user, wherein the first user is associated with the group ID;
store a second object data in the collective object database;
lookup the second user associated with the group ID; and
deliver the second object data to the second support hub of the second user.

6. The system of claim 5, wherein the display screen of the support hub is a touchscreen and the support hub further comprising:
a pen mount connected to the housing for storing a pen capable of stimulating a touch input of the touchscreen,
at least one of a writing recognition system and a second remote procedure call to the writing recognition system, the writing recognition system receiving a written input of the first user and generating the text output.

7. The system of claim 6, wherein the support hub further comprising:
an event database storing at least one of a jurisdiction event data, a personal event data, and a collective event data, and
a scheduling routine comprising computer readable instructions that when executed on the processor of the support hub:
receive the text output of the first user;
extract a date and optionally a time from the text output; and
record an event data as an instance of the personal event data in the event database.

8. A system for geospatial reminder and documentation, comprising:
a server comprising:
a processor of the server,
a memory of the server,
a network interface controller of the server,
a spatial documentation routine comprising computer readable instructions that when executed on the processor of the server:
receive a documentation placement request comprising a documentation content data comprising at least one of a text file of a documentation, a voice recording of the documentation, and a video recording of the documentation, and the documentation placement request optionally receive a documentation name and a documentation category;
receive a first location data from at least one of a mobile device and a wearable device;
generate a spatial documentation data comprising a documentation ID, the documentation content data, a documentation location data comprising a first coordinate of the first location data, and optionally the documentation name and the documentation category; and
store the spatial documentation data,
a documentation awareness routine comprising computer readable instructions that when executed on the processor of the server:
receive a second location data from at least one of the mobile device and the wearable device;
determine a second coordinate of the second location data is within a threshold distance of the first coordinate of the documentation location data;
determine an awareness indicator of the spatial documentation data;
wherein the awareness indicator is at least one of a sound and a vibration; and
transmit a first indication instruction to trigger the awareness indicator on the at least one of the mobile device and the wearable device, and
a network communicatively coupling the server and the at least one of the mobile device and the wearable device.

9. The system of claim 8, wherein the server further comprising:
a documentation retrieval routine comprising computer readable instructions that when executed on the processor of the server:
receive a documentation retrieval request comprising the documentation ID from at least one of the mobile device and the wearable device; and
transmit the at least one of the documentation name, the documentation content data, and the documentation category.

10. The system of claim 9, wherein the server further comprising:
a locating routine comprising computer readable instructions that when executed on the processor of the server:
receive an object placement request comprising an object name and optionally an object description data and an object category;
receive a third location data from at least one of the mobile device and the wearable device;
generate a placed object data comprising a placement ID, the object name and the object ID, an object location data, and optionally the object description data and the object category; and
store the placed object data,
an object locating routine comprising computer readable instructions that when executed on the processor of the server:
receive an object locating request comprising at least one of the object name, the object ID, and the object description;
determine at least one of a third coordinate of the object location data and an area name associated with the object location data; and
transmit at least one of the third coordinate and the object location name to at least one of the wearable device and the mobile device.

11. The system of claim 10, wherein the server further comprising:
at least one of a voice recognition system and a remote procedure call to the voice recognition system, the voice recognition system receiving a voice input of a first user and generating a text output, and
a set of computer readable instructions that when extracted extract from the text output at least one of:
(i) the documentation content data, the documentation name, and the documentation category, and
(ii) the object name, the object description data, the object category, and the area name.

12. The system of claim 8, further comprising:
the wearable device of the first user, comprising:
a display screen of the wearable device,
a processor of the wearable device,
a network interface controller of the wearable device,
an activation button of the wearable device that is at least one of a virtual button and a physical button, and
a voice transmission routine of the wearable device comprising computer readable instructions that when executed on the processor of the wearable device:
determine activation of the activation button;
record the voice input of the first user; and
transmit the voice input to the server.

13. The system of claim 12, wherein the server further comprising:
a group database storing an association between the user ID of the first user and a group ID;
a collective memory engine comprising computer readable instructions that when executed on the processor of the coordination server:
receive a fourth location data from at least one of a mobile device of a second user and a wearable device of the second user;
determine a user ID of the second user is associated with the group ID;
determine a third coordinate of the fourth location data is within the threshold distance of the coordinate of the documentation location data;
determine the awareness indicator of the spatial documentation data;
transmit a second indication instruction to execute the awareness indicator on the at least one of the mobile device of the second user and the wearable device of the second user;
receive a second object locating request comprising at least one of the object name, the object ID, and the object description from the at least one of the mobile device of the second user and the wearable device of the second user;
determine at least one of the third coordinate of the object location data and an area name associated with the object location data; and
transmit at least one of the third coordinate and the area name to at least one of the mobile device of the second user and the wearable device of the second user.

14. A computer implemented method in support of personal and/or team logistics, comprising:
receiving a reminder request comprising a reminder content data comprising at least one of a text file, a voice recording and a video recording, and further comprising at least one of a reminder category, and a user ID of a first user generating the reminder request,
generating a reminder condition data comprising a first reminder condition and a second reminder condition of higher urgency than the first reminder condition;
associating within the reminder condition data a first communication medium ID with the first reminder condition and a second communication medium ID with the second reminder condition;
generating a reminder data comprising a reminder ID, the reminder condition data, the reminder content data, and optionally the user ID of the first user generating the reminder request;
storing the reminder data;
determining the occurrence of the first reminder condition;
determining the first communication medium ID that is associated with the first reminder condition;
generating a reminder notification data comprising the reminder content data; and
transmitting the reminder content data through the first communication medium to at least one of a wearable device of the first user, a mobile device of the first user, and a different computer device of the first user.

15. The method of claim 14, further comprising:
determining the occurrence of the second reminder condition of the higher urgency;
determining the second communication medium ID that is associated with the second reminder condition; and
re-transmitting the reminder notification data through the second communication medium to at least one of the wearable device of the first user, the mobile device of the first user, and the different computer device of the first user.

16. The method of claim 15, further comprising:
extracting a first coordinate from a first location data received from at least one of the wearable device of the first user and the mobile device of the first user;
storing the first coordinate extracted from the first location data as the first coordinate of a reminder location data within the reminder data;
determining that at least one of a mobile device of the first user and the wearable device of the first user is within a threshold distance of the coordinate of the reminder location data,
wherein at least one of the first reminder condition and the second reminder condition moving within the threshold distance of the first coordinate of the reminder location data.

17. The method of claim 16, further comprising:
receiving a documentation placement request comprising a documentation content data comprising at least one of a text file, a voice recording, and a video recording, and optionally receive a documentation name and a documentation category;
extracting a second coordinate from a second location data received from at least one of the mobile device of the first user and the wearable device of the first user;
generate a spatial documentation data comprising a documentation ID, the documentation content data, a documentation location comprising a coordinate of the first location data, and optionally the documentation name and the documentation category;
storing the second coordinate extracted from the second location data as the second coordinate of the documentation location data;
storing the spatial documentation data;
determining that at least one of the mobile device of the first user and the wearable device of the first user is within a threshold distance of the second coordinate of the documentation location data;
determining an awareness indicator of the spatial documentation data;
wherein the awareness indicator is at least one of a sound and a vibration; and
transmitting an instruction to execute the awareness indicator on the at least one of the mobile device of the first user and the wearable device of the first user, and
receiving a documentation retrieval request comprising the documentation ID from at least one of the mobile device of the first user and the wearable device of the first user; and
transmitting the at least one of the documentation name, the documentation content data, and the documentation category.

18. The method of claim 17, further comprising:
receiving an object placement request comprising an object name and optionally an object description data and an object category;
extracting a third coordinate from a third location data received from at least one of the mobile device of the first user and the wearable device of the first user;
storing the third coordinate extracted from the third location data as the third coordinate of the object location data;
generating a placed object data comprising a placement ID, the object name, the object location data, and optionally the object description data and the object category;
storing the placed object data;
receiving an object locating request comprising at least one of the object name, the object ID, and a second instance of an object description data;
determining at least one of the third coordinate of the object location data and an area name associated with the object location data; and
transmitting at least one of the third coordinate and the object location name to at least one of the wearable device of the first user and the mobile device of the first user.

19. The method of claim 18, further comprising:
determining activation of an activation button of at least one of the wearable device of the first user and the mobile device of the first user;
recording a voice input of the first user;
transmitting the voice input to a voice recognition system;
receiving a text output from the voice recognition system; and
extracting from the text output at least one of:
(i) the text file of the reminder, the reminder category, and a name of the user to whom the reminder is addressed,
(ii) the text file of the documentation, the documentation name, and the documentation category, and
(iii) at least one of the object name, the object description data, and the object category.

20. The method of claim 19, wherein the user ID of the first user is associated with a group ID, and the method further comprising:
determine a second user is associated with the group ID;
determining the occurrence of the first reminder condition;
determining the first communication medium ID that is associated with the first reminder condition;
generating a reminder notification data comprising the reminder content data;
transmitting the reminder content data through the first communication medium to at least one of a wearable device of a second user, a mobile device of the second user, and a different computer device of the second user;
determining that at least one of the mobile device of the second user and the wearable device of the second user is within the threshold distance of the second coordinate of the documentation location data;
determining the awareness indicator of the spatial documentation data;
wherein the awareness indicator is at least one of a sound and a vibration; and
transmitting the instruction to execute the awareness indicator on the at least one of the mobile device of the second user and the wearable device of the second user, and
receiving a documentation retrieval request comprising the documentation ID from at least one of the mobile device of the second user and the wearable device of the second user;
transmitting the at least one of the documentation name, the documentation description, and the documentation category to the at least one of the mobile device of the second user and the wearable device of the second user;
receiving an object locating request comprising at least one of the object name, the placement ID, and the object content data from at least one of the wearable device of the second user and the mobile device of the second user;
determining at least one of the third coordinate of the object location data and an area name associated with the object location data; and
transmitting at least one of the third coordinate and the object location name to at least one of the wearable device of the second user and the mobile device of the second user,
wherein the reminder request and the reminder data further comprising a user ID of a second user to which the reminder content data is addressed.
